(19) United States
(12) Patent Application Publication
(10) Pub. No.: US 2019/0180380 A1
(43) Pub. Date: Jun. 13, 2019

(54) Computer Based Method of Pricing Equity Indexed Annuity Product with Enhanced Death Benefit

(71) Applicants: Genesis Financial Products, Inc., Mississauga (CA); The Annexus Group, Scottsdale, AZ (US)

(72) Inventors: Donald J. Dady, Cave Creek, AZ (US); Richard Kado, Oakville (CA); John Adam Rose, Toronto (CA); Ronald L. Shurts, Scottsdale, AZ (US); Marc Verrier, Caledon (CA)

(21) Appl. No.: 16/213,614

(22) Filed: Dec. 7, 2018

Related U.S. Application Data
(63) Continuation of application No. 11/784,974, filed on Apr. 10, 2007, now abandoned.
(60) Provisional application No. 60/793,666, filed on Apr. 20, 2006.

(51) Int. Cl. G06Q 40/08; G06Q 40/06

(52) U.S. Cl. CPC G06Q 40/08; G06Q 40/06

(57) ABSTRACT

A computer-based method for determining a set of equity-indexed crediting parameters I for an enhanced minimum death benefit guarantee equity-indexed deposit product also having a rider charge C, an enhanced minimum death benefit rollup percentage E, a set of profitability requirements R, a principal amount P, and an account value A, with C, E, R, P, A, and I determined at the time of product purchase. The method includes the steps of generating a set of yield curve and equity index scenarios consistent with valuation parameters, setting a trial value Iⱼ for I for said product, calculating the observed distribution D of profitability using the equity index scenarios, comparing D with R, and computing a revised trial value Iⱼ+1 for I for the product.

### CROSS-REFERENCE TO RELATED APPLICATIONS

This application claims the benefit, under 35 U.S.C. § 119(e), of U.S. Provisional Application No. 60/793,666 filed Apr. 20, 2006, which is hereby incorporated by reference.

### REFERENCE TO COMPUTER PROGRAM LISTING/TABLE APPENDIX

The present application includes a computer program listing appendix on compact disc. Two duplicate compact discs are provided herewith. Each compact disc contains an ASCII text file of the computer program listing as follows:

| Filename: | Size: | Date Created: |
|---|---|---|
| SIMPLX.CPP | 29 kb | Apr. 12, 2006 |
| Rmem4p.dpr | 29 kb | Apr. 12, 2006 |
| LMM1.DPR | 38 kb | Apr. 12, 2006 |
| rdb.log | 9098 kb | Apr. 12, 2006 |

The computer program listing appendix is hereby expressly incorporated by reference in the present application.

### FIELD OF THE INVENTION

The present invention relates to an equity-indexed annuity (EIA) that provides an enhanced guaranteed death benefit in addition to the guarantees and accumulation benefits that are typically found in EIAs.

### BACKGROUND OF THE INVENTION

Since their introduction in the mid-1990s, equity-indexed annuities (EIAs) have become very popular with annuity buyers. These products combine security of principal with participation in equity index returns. They are therefore appealing to buyers who are risk-averse but nonetheless want a chance to achieve the higher potential returns associated with equities. Recent sales statistics show EIAs making up 40% or more of life insurance general-account annuity sales, compared with almost none a decade ago.

In order to provide EIAs on a profitable basis, a life insurance carrier must have an appropriate investment strategy and hedging system in place. The potential for large losses if a carrier invests only in bonds, but offers guaranteed returns based on stock-market performance is obvious. See, for example, U.S. Pat. No. 6,049,772 for a description of the hedging activity and software required to support the issuing of EIAs.

Since the sharp decline in U.S. stock prices in early 2000, retail investors have developed a much greater appreciation of the risks of direct equity investment. As a result they have been increasingly willing to consider EIAs, because these are retirement savings vehicles that eliminate risks to principal while providing for equity-linked returns.

EIAs to date have included accumulation and guarantee provisions that make them suitable for accumulating assets and eventually generating retirement income. However, to date EIAs have not addressed another issue of key importance in financial planning: wealth transfer. Many annuity buyers are concerned about passing assets on to the next generation, but do not have the resources to set up a stand-alone insurance program entirely separate from their retirement savings program.

According to AARP's Survey of Consumer Finance 54% of Baby Boomers do not want any risk associated with their investments. This aversion to risk is the primary reason why hybrid products, those offering a combination of upside potential while providing downside protection, have flourished over the last decade. One of the most popular hybrid products over the last decade has been the Equity Indexed Annuity. Equity Indexed Annuity products offer some significant advantages for consumers. The Bequest Planning Annuity (BPA) takes these advantages and adds a level of flexibility and control that currently doesn't exist making it one of the most consumer friendly products on the market today.

BPA incorporates a unique balanced allocation of earnings that capitalizes on the well established time proven balanced allocation strategies. This crediting rate strategy eliminates the modifiers that add complexity and limit growth. In addition, BPA has unique liquidity features and death benefits.

There is no product on the market with the features incorporated in BPA. The carrier believes that the marketing organization for the product will have at least a 2 year lead time to recruit agents to Quality Life, the exclusive source for this product. Other products being marketed are either too complex or lack the benefits and optionality of BPA. BPA is founded on a simple concept and provides a clear structure that highlights the potential rewards of indexing while providing access to funds without onerous penalties and clawbacks of accrued index benefits.

Key features and benefits of BPA include: principal guarantee, less early withdrawal charges; minimum guaranteed earnings; simple balanced allocation strategy offering the opportunity for index growth without complicated formulas and modifiers; lock-in privilege that can be triggered at any time; unique free partial withdrawal feature that eliminates any earnings penalty, and unique rollup death benefit enhancement rider.

An EIA with an Enhanced Death Benefit allows annuity buyers to address this concern directly. Such a product allows for efficient asset accumulation and allows the buyer to defer the “income now vs. bequest later” choice for as long as possible. This reduces or eliminates the need to set up a stand-alone insurance program. As well, the risk-return profile of the enhanced product is one that many buyers will find more attractive. With the enhanced product, the buyer has: the potential for their retirement savings to earn the higher returns characteristic of an equity index, and the security of a death benefit that will grow at a market rate of interest, even if the equity index stays flat or declines over the long term.

Life insurance carriers have for some time provided enhanced guaranteed death benefits on variable annuities (VAs), but these are distinct from the benefit described here. They are much harder for a life insurance carrier to offer profitably, because they have much more basis risk, i.e. risk that the financial instruments available for hedging will fail to match the behavior of the liability.

Furthermore, VA death benefits typically are subject to a maximum ratio of benefit to initial premium, so that increases in benefits past policy year 15 or so are minimal. A benefit for which the value varied only by the duration since policy issue without being subject to an arbitrary cap would be more easily understood and more valuable to consumers.

For example, with respect to hedging, many of the mutual funds offered in a typical VA are actively managed. This means that their performance will generally not match the performance of readily-available hedging instruments such as S&P 500 futures, for at least three reasons: 1) The asset mix held by the mutual fund manager will have the same investment return as a quoted index only by coincidence; 2) The mutual fund will have higher trading costs and expenses than would be typical of investment in an unmanaged index through (for example) an exchange-traded fund; and 3) The fund manager may vary the allocation of assets between equities and fixed income in an attempt to outperform the market. Any such trading strategy will create additional optionality in the fund's values and make it harder for the life insurance carrier to hedge. Additionally, the owner of the variable annuity may transfer money from one fund to another or to a fixed interest account at unpredictable intervals, magnifying the basis risk problem.

Neither of these problems occurs with an EIA product, since performance is generally linked to an index that can be hedged using stock index futures, and reallocation between different indexing alternatives during an indexing term is typically not permitted. This vastly simplifies investment management for the product.

Calculation of VA statutory reserves is also much more complex and computation-intensive than calculating EIA reserves, at least given current regulatory requirements. VA reserves require calculation of a conditional tail expectation (CTE) of the greatest accumulated loss over a large number of scenarios and therefore require detailed Monte Carlo simulation of both assets and liabilities.

In contrast, EIAs, even with an enhanced guaranteed death benefit, can be valued using the Commissioners Annuity Reserve Valuation Method (CARVM) augmented with option valuation techniques in accordance with Actuarial Guidelines 33 and 35. In many cases, dependent on the guarantee and surrender charge structure of the product, it may be possible to establish that the statutory reserve is equal to the product's cash value, which will already be carried on the insurer's administrative system since it is needed for day-to-day administration.

Thus the EIA enhanced guaranteed death benefit can be offered more easily on a profitable basis, and has a number of operational advantages to the life insurance carrier, while still being attractive from the point of view of the buyer.

Accordingly, there is a growing consumer need for an EIA that can provide an enhanced guaranteed death benefit in addition to the well-known accumulation benefits and guarantees that EIAs typically provide. As a direct consequence, there is also a growing need among life insurance carriers for a computer-based system that can price such an EIA so that it can be provided on a profitable basis.

### SUMMARY OF THE INVENTION

The invention broadly comprises a computer-based method for determining a set of equity-indexed crediting parameters I for an enhanced minimum death benefit guarantee equity-indexed deposit product also having a rider charge C, an enhanced minimum death benefit rollup percentage E, a set of profitability requirements R, a principal amount P, and an account value A, with C, E, R, P, A, and I determined at the time of product purchase. The method includes the steps of generating a set of yield curve and equity index scenarios consistent with valuation parameters, setting a trial value for I for the product, calculating the observed distribution D of profitability using the equity index scenarios, comparing D with R, and computing a revised trial value Iⱼ+1 for I for the product.

In some aspects, the method can include the step of increasing the account value A at a maturity date M by an excess of a death benefit over the account value A, wherein the maturity date M is selected by a seller of the product. The method can also include the step of increasing the account value A at a maturity date M by an excess of a death benefit over the account value A, where the maturity date M is selected by an owner of the product on or after a purchase date of the product, and the maturity date M is subject to a earliest permissible date Mₘᵢₙ and a latest permissible date Mₘₐₓ.

The method of the present invention can also include the step of applying the enhanced minimum death benefit rollup percentage E only until a rollup limit date L, wherein the rollup limit date L is selected by a seller of the product. The method can also include the step of applying the enhanced minimum death benefit rollup percentage E only until a ratio of the enhanced minimum rollup death benefit to the principal P equals a maximum rollup limit ratio M selected by a seller of the product, wherein the ratio is adjusted for withdrawals.

The present invention also broadly comprises a computer-based apparatus for determining the value of an enhanced minimum death benefit guarantee equity-indexed deposit product which includes a means of storing a set of equity-indexed crediting parameters I, a rider charge C, an enhanced minimum death benefit rollup percentage E, a principal amount P, and an account value A, wherein the values of C, E, P, and I are determined at a time when the product is purchased, and a seller chooses I. The apparatus also includes a means for computing an observed distribution D of profitability of the product, and a means of comparing D to R such that D satisfies a set of profitability requirements R.

The computer-based apparatus can have an account value A that increases at a maturity date M by an excess of a death benefit over the account value A on the maturity date M, where the maturity date M is selected by the seller of the product. In some aspects, the account value A increases at a maturity date M by an excess of a death benefit over the account value A on the maturity date M, where the maturity date M is selected by an owner of the product on or after a purchase of the product, and the maturity date M is subject to an earliest permissible date Mₘᵢₙ and a latest permissible date Mₘₐₓ. The wherein enhanced minimum death benefit rollup percentage E can be applied only until a rollup limit date L, where the rollup limit date L is selected by the seller of the product. The enhanced minimum death benefit rollup percentage E can be applied only until a ratio of the enhanced minimum rollup death benefit to the principal P equals a maximum rollup limit ratio M selected by the seller of the product, where the ratio is adjusted for withdrawals.

It is a general object of the present invention to provide an EIA that can provide an enhanced guaranteed death benefit in addition to the well-known accumulation benefits and guarantees that EIAs typically provide.

### DETAILED DESCRIPTION OF THE PREFERRED EMBODIMENT

EIA death benefits are usually set as the larger of the Accumulation Value or the Cash Surrender Value in order to achieve compliance with the Standard Nonforfeiture Law for Individual Deferred Annuities (“SNFL”). In the current invention the EIA death benefit is modified to be the greatest of the following three values: The Accumulation Value—this is defined as in a traditional EIA; The Cash Surrender Value—this is also defined as in a traditional EIA; The Enhanced Death Benefit—this last value starts out as equal to the premium paid and then grows at a market rate of interest. This substantially improves the risk-return profile of the EIA for an annuity buyer with wealth transfer needs.

The Enhanced Death Benefit rider can be elected by the policy owner at issue. Once the rider is elected it generally cannot be dropped. On death of the annuitant, the beneficiary receives the greater of the death benefit calculated under the basic EIA death benefit calculation and the Enhanced Death Benefit. The Enhanced Death Benefit is equal to the premium accumulated at an interest rate that is set at issue. The premium is accumulated at that interest rate until the Rider Completion Date (in one embodiment this is the policy anniversary following the annuitant's 90th birthday, but other Rider Completion Dates are possible), and it is adjusted for any withdrawals.

At issue the Enhanced Death Benefit can be equal to the premium paid (also referred to as the principal amount P). Thereafter it increases at the stated rollup interest rate (also referred to as the enhanced minimum death benefit rollup percentage E) until the Rider Completion Date. Rollup interest rates of 4% and 5% have been priced but other rollup rates are also possible. Although the Enhanced Death Benefit stops increasing after the Rider Completion Date it can still be paid out after that date if it is higher than the basic EIA death benefit (which equals the account value A) at the date of death.

The maximum ratio of the rollup benefit to the account value can be limited to a maximum rollup ratio M, for instance M might be limited to 2. With a rollup rate of 5% that would limit the benefit to an amount equal to the initial premium for policy years 15 and later. In the current design the benefit increases based solely on the duration since issue, because this is easier for the owner to understand and provides a more valuable benefit to them. No maximum rollup ratio M is imposed, although this would be simple to implement and is within the spirit and scope of the claimed invention.

The rider premium can be guaranteed at the rate set at issue. A rider premium of 0.50% per year (also referred to as the rider charge C) has been priced but other rider premiums are possible. The premium is payable until the Rider Completion Date. The premium can be charged at the same time that interest is credited to the Accumulation Value (also referred to as the Account Value). The rider premium generally cannot exceed the amount of interest credited. Any portion of the rider premium in excess of the amount of interest credit will be waived, although it would also be possible to price the effect of accumulating unpaid rider premiums forward and offsetting them against later credited interest.

At the end of the Term, the interest credit can be reduced by the Accumulation Value times 0.50% multiplied by the lesser of (a) the number of years in the Term or (b) the number of years between the start of the Term and the Rider Premium Completion Date. However, the resulting credit should not be less than zero.

The Enhanced Death Benefit can be adjusted for any withdrawals. At the time a withdrawal is made, it is multiplied by an adjustment factor equal to (a) divided by (b) where: a) is the Accumulation Value immediately after the partial withdrawal and b) is the Accumulation Value immediately prior to the partial withdrawal.

This Enhanced Death Benefit Rider (Rider) shall be attached to and made part of the policy and is subject to all the terms, conditions and provisions contained in the policy. To the extent there are any conflicts between the provisions of this Rider and the provisions of the policy, the provisions of this Rider shall control. The effective date of this Rider shall be the policy date stated on the policy data page of the policy. There is an additional premium charge for this Rider. This Rider guarantees that any Death Benefit under the Death Benefit provision of the policy will be no less than the Enhanced Death Benefit defined below.

The Annual Rider Premium Rate can be used in the calculation of the Rider Premium. The Annual Rider Premium Rate can be the rate declared and in effect on the policy date and can be guaranteed for the life of the policy.

The Rider Premium can be deducted from the policy's Accumulation Value in the form of a reduction of the Index Factors that are used to calculate the interest credited to the policy. The Rider Premium Completion Date can be the date on which Rider Premiums will cease being deducted from the Accumulation Value of the policy. On the policy date, the Enhanced Death Benefit shall be equal to the Premium paid for the policy, reduced by any Premium Tax payable at that time.

In some aspects, between the policy date and the Rider premium completion date, the Enhanced Death Benefit shall be equal to the Premium paid for the policy accumulated at an effective annual interest rate of 5.00% (in some embodiments other enhanced minimum death benefit rollup percentages are possible) and reduced proportionally for any Withdrawals (including Free Withdrawals) from the policy. For this purpose, the proportional reduction for each Withdrawal shall be an amount equal to the Enhanced Death Benefit multiplied by [1−(A/B)] where: A is the Accumulation Value after any such Withdrawal. B is the Accumulation Value prior to any such Withdrawal.

If a Death Benefit is determined under the Death Benefit provision of the policy, and it is less than the Enhanced Death Benefit on the date the carrier receives due proof of death of the Owner, then the Death Benefit will be increased to equal the Enhanced Death Benefit.

The Maturity Date will be the later of the Maturity Date described in the Maturity Date provision of the policy or the end of the Indexing Term nearest the Annuitant's 100th birthday (in some embodiments other dates such as the 95^{th} or 105^{th} birthday are also within the spirit and scope of the claimed invention). If Joint Annuitants are named in the application, the Maturity Date will be set based on the age of the oldest Joint Annuitant.

The Cash Surrender Value of the policy will be increased, on the Maturity Date, to an amount equal to the Enhanced Death Benefit prior to determining the amount of annuity payments if all of the following conditions are met: 1.) The policy is in force on the Maturity Date; 2.) The Cash Surrender Value on the Maturity Date is less than the Enhanced Death Benefit; and 3.) The Cash Surrender Value is applied under any of the Settlement Options available under the policy.

Neither the Owner nor the carrier may elect to terminate this Rider once it has been attached to and made part of the policy. The Rider will terminate only upon (1), (2) or (3) where: (1) is the date on which the policy's Death Benefit is paid; (2) is the date on which a Settlement Option is elected under the policy; and (3) is the date on which the policy is surrendered for its Cash Surrender Value. If the policy is surrendered by the Owner prior to the payment of a Death Benefit or the election of a Settlement Option on the Maturity Date any potential value associated with this Rider will be forfeited.

Programs can be implemented in APL2000′s APL*PLUS Windows Version 3.6, Borland's Delphi 4.0, and Borland C++. The APL language uses a special character set which includes a number of non-ASCII characters. Jim Weigang's well-known reversible transliteration scheme can be used to display APL source code using only ASCII characters. Because the transliteration scheme is reversible, standard utilities can be used to reconstruct the APL source for execution by the APL interpreter.

The pricing program can calculate profitability (the observed distribution of profitability D) for a model office with issue ages 55, 67, 72, 77, and 83, although other ages can be chosen. To determine expected profitability for the model office of equity-indexed annuities including the lifetime income benefit, (the observed distribution of profitability D which will be compared by the program with the set of profitability requirements R iteratively until convergence is reached) perform the following steps: Compile the dynamic link libraries (DLL's) in the directory where the APL interpreter (aplw.exe) resides. The source for lmm1.dll and rmem4p.dll is written in Delphi and the source for simplex03.dll is written in C++; Start the APL2000 interpreter aplw.exe, and set working memory to approximately 256 Megabytes using the APL command)CLEAR 256000000; Load the APL workspace C341REVB. Settings for running the program are contained in the character matrix delphi_c3p_31_12yr_qualit; To run the system type megarun_cpp and hit enter. The program will run for four hours or so, iterating in order to meet the profit requirements for the model office (assumed distribution of new business by age and sex). The profit results (expressed as after-tax return on investment calculated on a U.S. statutory reserve basis) are shown for ages 55, 67, 72, 77, and 83. Additionally, the ROI for the model office in aggregate is shown, along with secondary profit measures (standard deviation of ROI, 5th percentile of ROI, and premium margin) along with statutory strain (a measure of how much capital is required to support new business written).

### Rider Weights

0.05940594059 0.07425742574 0.5940594059 0.1361386139 0.1361386139

### Profit for age 55: 14.0327

### Profit for age 67: 13.8102

### Profit for age 72: 13.2562

### Profit for age 77: 12.0955

### Profit for age 83: 14.4428

| | | | | |
|---|---|---|---|---|
| 14.03 | 5.08 | 8.04 | 3.63 | 12.86 |
| 13.81 | 5.04 | 7.67 | 3.53 | 12.86 |
| 13.26 | 4.96 | 6.64 | 3.26 | 12.86 |
| 12.10 | 4.95 | 4.63 | 2.73 | 12.88 |
| 14.44 | 5.35 | 6.59 | 3.18 | 12.29 |
| 13.33 | 5.00 | 6.51 | 3.22 | 12.79 |

Financial planners often use a concept called “Capital Preservation”. A portion of the owner's principal is invested with guaranteed fixed interest sufficient to grow back to the original principal at the end of the desired investment horizon. This guarantees that the owner will get their principal at that time. The remainder is invested in equity markets, providing the potential for excess return. Unfortunately, with today's low interest rates, an investor needs to put almost all the money in fixed interest, leaving very little in stocks. For example, if an owner has $100,000 to invest over a 4-year time horizon, and earns a 4-year guaranteed rate of 4%, then they must put $85,480 in fixed interest, leaving only $15,520 invested in equities. In other words, less than 16% of funds reflect equity market performance. As a result, the Capital Preservation concept is no longer workable in its traditional format.

BPA is an equity indexed annuity (EIA) which improves on the capital preservation concept by consolidating the fixed interest and equity indexed portions into a single product, and providing the principal guarantee for the product rather than for each component. The resulting product allows 35-40% of assets to reflect equity market performance (versus 16% in a classic capital preservation plan) while still guaranteeing a return of principal at the end of the time horizon. In order to maximize the potential growth, BPA has been designed with a 12 or 8 year withdrawal charge and within that a series of 4 year point-to-point indexing terms (the Term). In order to provide additional flexibility similar to that found in other capital preservation plans, BPA provides a unique early lock-in privilege which allows owners to lock-in their gains at any time during the four year indexing interval and stop any exposure to any changes in the equity index after that time. As well, this feature allows policy owners to surrender prior to the end of any Term without forgoing all earnings like all other point to point EIAs. Instead owners receive a pro-rata portion of any gains in the policy at the time of surrender.

To provide additional liquidity, BPA provides a unique free partial withdrawal privilege which allows owners to receive full index gains at the time of the free withdrawal. This enhanced free withdrawal with gains is also offered for 100% withdrawal in case of confinement or terminal illness.

To round out the picture, BPA offers an enhanced minimum guaranteed death benefit rider, which guarantees that the death benefit will be no less than the original premium accumulated with interest up to age 90. (The death benefit is adjusted for withdrawals.)

BPA is an equity indexed single premium deferred annuity. Issue ages are 0-85 for the 8-year version Withdrawal Charge version, and 0-80 for the 12-year Withdrawal Charge version. Although it is envisioned that other variations on these versions are possible and considered within the spirit and scope of the current invention. Any rates described are preliminary and can be adjusted as a carrier confirms pricing and move closer to product launch. As well, any rates, multipliers, factors, etc, should be treated as variables which can change for different issue dates.

A Balanced Allocation Strategy is used to describe the interest crediting methodology. Interest can be based on a blend of an equity index and a declared rate earnings. The equity index allocation can be based on the Standard & Poor's 500 Index (S&P 500 Index) or other equity index, and the Declared Rate allocation can be based on the Declared Rate which the carrier will determine at the beginning of each Term.

When the premium (the principal amount P) is paid, the carrier will declare the Calculation Factors for the initial Term; these factors are guaranteed for the entire Term. The Calculation Factors specify how the capital preservation concept will be applied in the upcoming Term. In particular, the carrier can declare: the Equity Indexed Allocation Percentage; the Declared Rate Allocation Percentage (together 100%); the Declared Rate; and the Asset Expense Charge Rate. These Calculation Factors are also referred to as the set of equity-indexed crediting parameters I.

Gains accrued during the Term are credited to the Accumulation Value at the end of the Term. At that time, the sum of the declared rate earnings and equity market gain/loss participation, subject to a floor of zero on the sum, is applied to the Accumulation Value. However, at any time during the Term, owners can elect to trigger the Lock-in Date and “lock in” of their combined gains.

If a policy owner elects an early lock-in, they can be immediately credited with the Index Earnings. Index Earnings are calculated as the sum of the declared rate earnings to date, and a pro-rata portion of the then-calculated equity index gain/loss, subject to a floor of zero on the sum. For the rest of the Term, the policy receives Guaranteed Interest earnings which are equal to the sum of the declared rate applied to the Declared Rate Allocation, and daily installments of the remaining index gains that were not credited on the Lock-in Date. This combination is expressed as a single guaranteed interest rate that is credited from lock-in to the end of the Term.

After the end of each Term, a new 4-year Term begins and the carrier declares new Calculation Factors for that Term. The Cash Surrender Value is equal to the greater of (a) the Accumulation Value adjusted for a market value adjustment (MVA) and less a Withdrawal Charge, or (b) the Minimum Guaranteed Contract Value. In some aspects, the Minimum Guaranteed Contract Value is 87.5% of the single premium less withdrawals accumulated with interest. The carrier will set the nonforfeiture interest rate for BPA in the same manner as its other EIA products. The product can have an 8 year or 12 year Withdrawal Charge period.

A rider to enhance the death benefit can be available, providing a guaranteed minimum death benefit equal to the premium rolled up at 5% for the 12 year design and 4% for the 8 year design. The rider premium can be deducted from policy earnings at the time they are credited to the policy and should not exceed the earnings. The rider premium can be 0.50% of the Accumulation Value per year.

For example purposes the following sample Calculation Factors (set of equity-indexed crediting parameters I) are provided for the first Term: 40% Equity Indexed Allocation for the 12-year product and 35% for the 8-year product; 60% Declared Rate Allocation for the 12-year product and 65% for the 8-year product; and for both products, the declared rate is 1.95%. The Asset Expense Charge Rate for product launch is 0%, but it may change at some point in the future for new issues.

The Term is defined as “the length of time for which interest on the Accumulation Value is calculated based on a particular set of Calculation Factors.” Each successive Term begins at the end of the immediately. preceding Term, and a new set of Calculation Factors is declared at that time. The current design will use four-year terms.

During each four year Term, the Accumulation Value stays level until the end of that Term, unless the owner requests an early lock-in before the end of that Term. The starting Accumulation Value for the first Term is equal to the Premium less any premium tax if deducted at issue. The starting Accumulation Value for the second Term equals the premium, less any withdrawals, plus any earnings credited during the first Term.

Owners can elect an early lock-in of the Index Earnings at any time during the Term. If an early lock-in is elected by the policy owner then the Index Earnings are added to the Accumulation Value at the time of the early lock-in. The Index Earnings are equal to the sum of the declared rate earnings to date, and a pro-rata portion of the then-calculated equity index gain/loss, subject to a floor of zero on that sum. From that time until the end of the Term, the account can function like a standard fixed SPDA with one exception: the interest rate is unique to each situation and is calculated at the time of early lock-in. During this time period, withdrawals impact the Accumulation Value in the same manner as they impact it for a standard SPDA. After the Withdrawal Charge period, the Accumulation Value grows with ongoing 4 year Terms.

Calculation factors are set at the start of each Term. BPA provides a balance of earnings consisting of a declared rate component and an equity indexed component. The allocation between the two, as well as the declared rate, can be set by the carrier as part of the normal rate setting process. It is guaranteed for the full four year Term. New factors are set by the carrier at the start of each subsequent Term (and guaranteed for that term).

An Earnings Formula can be used for calculating the Index Earnings Factor and the Balanced Allocation Factor which in turn are used in the following calculations: (i) for normal earnings crediting at the end of the four year Term if the owner did not elect a lock-in during the Term; (ii) for calculating the immediate credit upon an owner requested lock-in as well as calculating the interest earnings credited after lock-in; (iii) for any free partial withdrawal calculation; (iv) for any death benefit calculation; and (v) for calculating the Balanced Allocation Value.

The formula equals the sum of the combined earnings (A plus B) minus any charges (C plus D), but not less than zero. (A) is equal to the product of the following: the Equity Indexed Allocation Percentage declared at the start of the Term; the change in the S&P index (measured by comparing the index value on the start of the Term to the Ending Index Value, defined below, on the Lock-in Date); and the Pro-Rata Factor for that date, as defined below. (B) is equal to the product of the following: the Declared Rate Allocation Percentage declared at the start of the Term; and the Declared Rate compounded from the start of the Term to the Lock-in Date (i.e. if the Declared Rate is 1.95%, then (1+0.0195)^{t}−1 where t is the Elapsed Term). (C) is equal to the product of the following: the annual percentage cost of any rider attached to the policy; and the elapsed time in the current Term. The elapsed time for the rider charge is expressed in years with a fraction for partial years. It is the lesser of the (a) the Elapsed Term or (b) the rider elapsed time from the start of the Term to Rider Premium Completion Date.(D) is equal to the product of the following: the Asset Expense Charge Rate declared at the start of the Term; and the Elapsed Term

In this formula, item A is allowed to be negative. However, the total value (A+B−C−D) is never allowed to be less than zero. For this calculation, the Equity Indexed Ending Value is defined as follows: At the end of the Term, the Equity Index Ending Value is the average of the S&P 500 (or other equity index) values published during the last 30 calendar days of the Term. Other averaging periods are also within the spirit and scope of the claimed invention.

On any other date during a term (the date of death, on determination of the Balanced Allocation Value, on a free partial withdrawal, or upon lock-in prior to the end of the Term), the Equity Index Ending Value is equal to the S&P Index Value on that day (or if the index is not published that day then the most recently published index value).

The only difference between the Balanced Allocation Factor and the Index Earnings Factor is the way that the Pro-rata factor is defined in item A above. In calculating the Index Earnings Factor, the Pro-Rata Factor is the time since the start of the Term divided by the total length of the Term. The measurement of time should be in actual days passed divided by actual days in the Term (i.e., taking leap years into account). In calculating the Balanced Allocation Factor, the Pro-rata factor is set equal to one. At lock-in the Balanced Allocation Factor is set equal to zero. This allows the owner to use the same FPW formula after lock-in.

The Balanced Allocation Factor and the Balanced Allocation Value are terms defined in the policy form to help explain earnings, FPW and death benefit calculations. The Balanced Allocation Value is included on each anniversary statement and thus provides the policy holder lock-in information as of the last policy anniversary. The Balanced Allocation Value is equal to the Accumulation Value times the Balanced Allocation Factor. This definition result in the following values being used in the formula described above.

The Lock-in Date is the date when the Balanced Allocation Value is being calculated. The Elapsed Term is the time elapsed from the start of the current Term to the Lock-in Date. The elapsed time is expressed as years with fractional amounts.

The S&P Index value (or other equity index value) published on the date for which the Balanced Allocation Value is being calculated is called the Pro-Rata Factor One Equity Index Ending Value. The carrier does not anticipate calculating the Balanced Allocation Value at the end of the Term. If it is calculated at that point then the average of the index values published during the last 30 days can be used.

If Lock-In is not elected during a Term, then at the end of the Term the combined earnings will equal to the Accumulation Value at the end of the term times the Index Earnings Factor.

The policy anniversary at the end of the Term becomes the Lock-in Date, if the owner has not previously selected a Lock-In Data before the end of the Term. The Elapsed Term can be four years. The average of the index values published during the last 30 calendar days of the term is the Pro-Rata Factor One Equity Index Ending Value. In the situation where the owner elects to lock in their gains during the Term, the interest credited to the Accumulation Value is equal to: first, the Index Earnings which are credited immediately on the Lock-in Date; and second, the guaranteed interest rate (g) credited from the Lock-in Date until the end of the Term. The next sections describe how to calculate these items. The immediate credit is equal to the Accumulation Value on the early lock-in date times the Index Earnings Factor. The date the Owner's lock-in request was received in good order by the carrier can be termed the lock-in date.

The time elapsed from the start of the current index term to the Lock-in Date is the Elapsed Term (for use in calculating pro-rata factor and items B, C and D). The elapsed time is expressed as years with fractional amounts. The Pro-Rata Factor is the Elapsed Term divided by the length of the Term. The Equity Index Ending Value is the S&P Index value published on the Lock-in Date.

Between the lock-in date and the end of the Term, the Accumulation Value earns daily interest at the guaranteed rate in the same way as a normal SPDA (single premium deferred annuity). The guaranteed rate is calculated at the time of lock-in and is guaranteed for the remainder of the Term. This guaranteed rate will be different for each policy that elects to lock-in.

The guaranteed rate is determined so that at the end of the Term, the Accumulation Value will equal a target accumulation value. From a marketing viewpoint, this target accumulation value can be thought of as: the Accumulation Value immediately prior to lock-in; plus the equity indexed allocation earnings (without any pro-rata adjustment) calculated at lock-in; plus declared rate allocation earnings for the entire Term; minus any rider charges or asset expense charges. This target accumulation value is equal to the Accumulation Value immediately prior to lock-in times 1 plus the Index Earnings Factor with the following values in the formula described above.

The carrier solves for the guaranteed rate (g) such that the following formulas provide the same result. In the formula below t is the time of lock-in, and items A, B, C and D are as defined above. A is the equity indexed allocation earnings calculated at the time indicated and using the appropriate pro-rata factor for that time; B is the declared rate allocation earnings; C is the rider premium charge; D is the Asset Expense Charge; and RT is the time remaining in the Term.

The following two formulas must have the same value.((AVₜ)(1+Aₜ+B_{end of term}−C_{end of term}−D_{end of term})) ((AVₜ)(1+Aₜ+Bₜ−CₜDₜ) ((1+g)^{RT}). Therefore g is equal to [(1+Aₜ+B_{end of term}−C_{end of term}−D_{end of term})/(1+Aₜ+Bₜ−Cₜ−Dₜ)]^{(1/RY)}−1. Note that the annual rider premium is multiplied by the elapsed time indicated in the formula. This time period should be tested such that it does not exceed the Rider Premium Completion Date.

At the time of an early lock-in, the owner will receive a confirmation statement informing him or her of the guaranteed rate for the rest of the term. This confirmation should include at least the following items: the amount of earnings credited to the Accumulation Value on the lock-in date; the resulting new Accumulation Value; and the interest rate for the remainder of the term. In practice it may be best to send a confirmation that includes more information and follows the layout of the annual statement.

After the end of the Withdrawal Charge period, the four year Terms can continue. The policy form allows for expense charges. The initial launch version of the product will have expense charges set to zero for all Terms. The index used in this product can be the S&P 500 Composite Price Index or another equity index. The policy form provides the flexibility of using a different index. The index value used on any given policy anniversary will be the value of the index on the close of business on that date. If the policy anniversary falls on a day that the index is not published (weekend or holiday) then the most recently published index value can be used.

Note that the Lock-In provision can be triggered by the owner on any date. Thus, the system must reference the index value on dates other than policy anniversaries. If the carrier processing date falls on a date that the index is not published then the most recently published index value will be used.

The percentage change of the S&P index (or other equity index) is measured by comparing the S&P index at the start of the Term to the Equity Index Ending Value. At the end of the Term, the Equity Index Ending Value is the average of the S&P 500 values published during the last 30 calendar days of the Term. On any other date (i.e. for death benefits, for determining the Balanced Allocation Value, for any free partial withdrawals, or upon lock-in prior to the end of the Term), the Equity Index Ending Value is equal to the S&P Value on that day (or if the index is not published that day then the most recently published index value). Note that the percentage change can be a negative number. Thus equity indexed allocation earnings can erode any declared rate allocation earnings but they can not erode principal since the combined earnings can never be less than zero.

In each policy year, including the first, there is no Withdrawal Charge or Market Value Adjustment on partial withdrawals of up to 10% of the Accumulation Value as of the first partial withdrawal, or the RMD (required minimum distribution if qualified).

Typical EIA products penalize policy owners who take free partial withdrawals other than on an index crediting anniversary. Under those designs, intra-term free partial withdrawals do not participate in any index earnings. BPA can include the innovative concept of including earnings to date for any FPW. This concept applies before lock-in. After lock-in the withdrawal is processed like any other normal SPDA. If the FPW is before lock-in then the Balanced Allocation Factor is calculated on the withdrawal date. This factor, as described above is the gain to date for the combined declared rate allocation earnings and indexed allocation earnings.

The amount deducted from the Accumulation Value can be the FPW amount paid to the owner divided by one plus the Balanced Allocation Factor. Since one plus the Balanced Allocation Factor is usually greater than or equal to one, the amount withdrawn from the Accumulation Value will usually be less than or equal to the FPW amount received by the owner. The FPW limit is approximately 10% of the Accumulation Value at the time of the first withdrawal during the year. This is a change from standard carrier practice of using 10% of the Accumulation Value at the previous anniversary. If an owner locks in and receives an index credit part way through a year then they would expect the free withdrawal limit to be approximately 10% of the Accumulation Value at that time, including that index credit.

For example, suppose the premium is $10,000 at issue and the owner locks in after 2 1/2 years and the Accumulation Value grows to $15,000. Suppose the owner makes a free withdrawal at that time, the expectation would be that the free withdrawal amount would be 10% of $15,000 and not 10% of the year-start value of $10,000. Note that after lock-in the free withdrawal amount requested equals the amount withdrawn from the Accumulation Value. In some aspects, any withdrawal in excess of the FPW will not include any gains to date calculation and will include a deduction for Withdrawal Charges and a market value adjustment.

Note that (a) free partial withdrawals are available in the first policy year, and (b) the policy form currently does not impose any limit on the number of withdrawals. It simply defines the minimum withdrawal to be $300 (this is the amount withdrawn from the Accumulation Value not the amount received—see discussion supra). Systematic withdrawals can be limited to monthly EFT.

The policy allows a free partial withdrawal of the entire Accumulation Value when the annuitant is confined to a care facility or upon their terminal illness. Withdrawals under the terminal illness or confinement waivers can be treated as free partial withdrawals and thus can receive the same treatment as other free withdrawals, namely: surrender charges and the MVA can be waived; if the withdrawal occurs before the lock-in date, the amount deducted from the Accumulation Value can equal the amount paid to the owner divided by (1+Balanced Allocation Factor).

The Cash Surrender Value is the greater of (a) the Minimum Guaranteed Contract Value and (b) the Accumulation Value modified by the market value adjustment less a Withdrawal Charge. However, the Withdrawal Charge and MVA are waived on payments to the owner up to 10% of the Accumulation Value withdrawn each year. Up to this limit, the amount withdrawn from the Accumulation Value can be less than the amount paid to the owner. For any withdrawals in excess of that amount there can be a Withdrawal Charge and MVA.

For the 12-year design the Withdrawal Charge scale can be: 13.5%, 13%, 12.5%, 12%, 11%, 10%, 9%, 8%, 7%, 6%, 5%, 3%, and finally 0% of the amount withdrawn in excess of the free withdrawal amount in some embodiments, although other Withdrawal Charge scales are also possible. For the 8-year design the Withdrawal Charge scale can be: 10%, 9%, 8%, 7%, 6%, 5%, 4%, 3%, and finally 0% of amount withdrawn in excess of the free withdrawal amount.

If an owner requests a full surrender before Lock-In then it could be carrier practice to Lock-In the policy before proceeding with the surrender. This raises the question of whether the FPW should be done before or after Lock-In. Depending on the change in the S&P index, either method can generate better results. To ensure the best possible result for the owner the calculation can be done on both methods with the better method selected for each request. The amount withdrawn up to the FPW limit will be treated as described herein. Any withdrawal in excess of that amount will be processed the same way as current carrier practice, i.e., it will include a Withdrawal Charge and an MVA and no index credits.

The policy can include a modification from normal carrier practice for confinement and terminal illness. The normal carrier definition can be used. However, 100% of the Accumulation Value can be depleted without any Withdrawal Charge or MVA. Note that this means, assuming no prior lock-in, that if the owner withdraws all available funds then the cash received will equal 100% of the Balanced Allocation Value.

In some aspects, a market value adjustment applies on surrenders in excess of the free partial withdrawal limit, and it does not apply to the Minimum Guaranteed Contract Value. The formula is described below.

The MVA is calculated as follows: (50%)(a−b)(n/12); “a” is the 10-year Treasury Rate at issue; “b” is the 10-year Treasury Rate published on the day before the surrender or withdrawal is processed plus 0.25%; “n” is the number of complete contract months remaining until the end of the withdrawal charge period. In some embodiments, any positive MVA cannot exceed the Withdrawal Charge and any negative MVA cannot exceed the interest paid to date, but other changes to the MVA formula are also within the spirit and scope of the claimed invention.

The Minimum Guaranteed Contract Value is a secondary guarantee that defines the minimum Cash Surrender Value and death benefit for the policy. The initial Minimum Guaranteed Contract Value can be 87.5% of the single premium. The Minimum Guaranteed Contract Value is accumulated at the minimum guaranteed interest rate. This rate can be set at issue to satisfy the nonforfeiture law the same way as it is set for the equity indexed buckets on other EIA products. Any partial withdrawals reduce the Minimum Guaranteed Contract Value by the amount paid to the owner.

Note that the deduction is in some aspects the “amount paid”; this can be different from the amount deducted from the Accumulation Value in many ways: for free withdrawals, the deduction from Accumulation Value is always less than or equal to the amount paid to the owner as described above. For non-free withdrawals, the amount paid can be equal to the amount deducted from the Accumulation Value, less any Withdrawal Charges and after applying any MVAs (i.e., the amount paid is reduced by any negative MVAs and increased by any positive MVAs). There is no top-up of the Minimum Guaranteed Contract Value.

The initial Accumulation Value is the single premium (the principal amount P). Current practice is not to deduct any applicable state premium taxes at issue. The Accumulation Value earns interest as described above. The Accumulation Value is decreased by any partial surrenders, including any applicable Withdrawal Charges and MVA. However, in the case of a free withdrawal, the decrease in the Accumulation Value can be less than the amount paid to the owner, as described above.

The death benefit can be paid upon receipt of proof of death of the annuitant. The basic death benefit (i.e., the death benefit in the absence of the enhanced death benefit rider) is the greater of (a) the Cash Surrender Value reflecting any market value adjustment, and (b) the Balanced Allocation Value ignoring any Withdrawal Charge or market value adjustment, as of the date of receipt of proof of death. The death benefit is paid on the death of the annuitant. If the beneficiary of the death benefit is a spouse of the annuitant then the spouse can continue the policy in which case no death benefit is paid at that point.

In some aspects, the enhanced death benefit rider can be elected by the policy owner at issue. The rider cannot be dropped once elected. On death of the annuitant, the beneficiary receives the greater of the basic death benefit under the annuity and the Enhanced Guaranteed Minimum Death Benefit. The enhanced death benefit is equal to the premium accumulated at an interest rate (the enhanced minimum death benefit rollup percentage E) that is set at issue. The premium is accumulated at that interest rate until the Completion Date, and it is adjusted for any withdrawals.

At issue the enhanced death benefit can be equal to the premium paid (the principal amount P). Thereafter, it increases at the stated interest rate (the enhanced minimum death benefit rollup percentage E) until the completion date. The rollup interest rate can be 4% for the 8 year design and 5% for the 12 year design, although these rates can fluctuate with market changes. The roll up completion date can be the policy anniversary following the annuitant's 90th birthday (although other rider completion dates are possible and are within the spirit and scope of the claimed invention). Although the death benefit stops increasing after the completion date it is still paid out after that date if it is higher than the basic annuity death benefit at the date of death.

The rider premium can be guaranteed at the rate set at issue. It can be 0.50% per year, although this value can fluctuate. The premium is payable until the rider completion date (the policy anniversary following the annuitant's 90th birthday), but this date can be adjusted. The premium is charged at the same time that interest is credited to the Accumulation Value. The rider premium will not exceed the amount of interest credited; therefore any portion of the rider premium in excess of the amount of interest credit will be waived.

In some aspects, the treatment of rider premiums is contained in the formulas for the Indexed Earnings factor and the Balanced Allocation Factor. A text explanation of those formulas is as follows: If an owner does not elect lock-in during a Term, then at the end of the Term, the interest credit is reduced by the Accumulation Value times 0.50% multiplied by the lesser of (a) the number of years in the Term or (b) the number of years between the start of the Term and the Rider Premium Completion Date. However, if the resulting credit would be less than zero then it is set at zero.

If an owner elects lock-in during a Term, then at that time, the resulting credit is reduced by 0.50% times the lesser of (a) the number of full years plus a fraction for the partial year since the start of the Term and (b) the time between the start of the Term and the Rider Premium Completion Date. At lock-in the guaranteed rate (g) is calculated, and the formula for this rate automatically adjusts for any outstanding rider premiums.

The Enhanced Death Benefit can be adjusted for any withdrawals. At the time a withdrawal is made, it can be multiplied by an adjustment factor equal to (a) divided by (b) where: a) is the Accumulation Value immediately after the partial withdrawal and b) is the Accumulation Value immediately prior to the partial withdrawal.

The policy will include the usual “persons” found within a deferred annuity contract. The contract is annuitant driven not owner driven. This includes: a) Annuitant—the life that is being used to measure the starting date of annuity income payments; the death benefit is paid on the death of the annuitant; joint Annuitants are permitted; the Annuitant(s) can not be changed after issue; b) Payee—the person to receive the annuity income—this will always be the annuitant; c) Owner—there can be multiple owners (primary, secondary, joint); d) Beneficiary—there can be multiple beneficiaries (primary, secondary, multiple). Issue Age—the minimum age is zero. The maximum issue age for the annuitant can be age 85 for the policy with an 8 year Withdrawal Charge period and age 80 for the policy with a 12 year Withdrawal Charge period.

If the age or sex of the annuitant is misstated, then at annuitization, the annuity payments will be adjusted to what they should have been had the correct age and/or sex had been used.

The free look period will vary by state and will follow normal carrier practice. In most situations, the policy may be returned within 10 days after delivery of the policy. All premiums paid, less any partial surrenders, can be refunded without penalty.

Policies can be issued on a daily basis. The Issue Date can be two working days after the date that the premium is paid. For 1035 exchange policies this is the date that the last funds are received by the carrier. The Issue Date does not have to be a date that the New York Stock Exchange (NYSE) is open.

The starting S&P index value for 1035 exchange policies will be the date funds are received. Normal rate guarantee procedures will apply for this product. The rate guarantee time period varies and will be published with any new rate announcement. The rate guarantee will apply from the date the application was signed. That means, for up to the number of days specified on the rate sheet, the equity-indexed allocation and the declared rate will be the higher of the rates in effect the date the application was signed or (b) the date funds were received by the carrier.

Shortly after each policy anniversary an annual statement will be sent to the owner. This is designed to be a single premium plan. Generally, there are no further premiums allowed if a single premium format is chosen. Roughly, the minimum premium can be $5,000 for non-qualified and $2,000 for qualified. The maximum single premium is $1,000,000 (without prior carrier approval).

Between anniversaries, the system should provide the following information. Depending on systems capabilities some of that information may be available on-line or by telephone access to policy owners, or limited to the carrier's service staff: whether the owner has elected an early lock-in for that Term; the current declared rate in effect (only if prior to early lock-in); current guaranteed rate in effect (only if after early lock-in); the current S&P Index value and the S&P Index at the start of the current; Term: the current Balanced Allocation Value; if prior to early lock-in, the information on how all the components were calculated must also be available in case an owner wants to understand the details of the calculation; the current Accumulation Value; what the Account Value would be if the owner locked in immediately, and the resulting Cash Surrender Value; the end-of-term Accumulation Value if the owner locked in immediately; and the Maximum Free Partial Withdrawal amount available and the amount that will be deducted from the Accumulation Value for that withdrawal.

The policy will terminate at the earliest of: full surrender; death (unless continued by a surviving spouse); or maturity. The Cash Surrender Value can be the Accumulation Value less the Withdrawal Charge and modified by the MVA, but it is never lower than the Minimum Guaranteed Contract Value. If the policy has not been locked-in prior to surrender then a lock-in should be automatically triggered. The order of processing is described in more detail herein.

Normal carrier practices should be applied, as to whether the beneficiary has the right to continue the policy on the death of the owner of the annuitant. Normal current carrier practice should apply for benefits paid upon the death of the owner. The death benefit for the annuitant is greatest of: Balanced Allocation Value or Cash Surrender Value.

In some aspects, the annuitant must commence receiving income payments if the contract is in force on the Annuity Date, and the Annuity Date will equal the anniversary immediately after the oldest annuitant's 100^{th} birthday. The annuity value can be the Cash Surrender Value. If the owner has not yet elected an early lock-in for the current term, a lock-in should be processed prior to annuitizing. Alternatively, the owner can apply his or her Cash Surrender Value at any time to purchase an immediate annuity under the basis guaranteed in the contract. The carrier can waive Withdrawal Charges and MVA according to normal carrier practices. For example: in years 2-5 the SPIA should be for 8 years or longer; In years 6+ the SPIA should be for 5 years or longer.

The policy includes carrier standard language for qualifying for the waiver of Withdrawal Charges and MVA upon confinement or terminal illness. The percentage payout has been increased such that the owner can deplete 100% of the Accumulation Value without incurring any Withdrawal Charges or MVA. Any withdrawal under either waiver is processed just like a normal free partial withdrawal (i.e., it includes gains to date as described above). That means the owner will receive 100% of the Balanced Allocation Value if they deplete 100% of the Accumulation Value.

Once sales volumes are sufficient, a PC based “Hedge Inventory System”, customized for the BPA design and the needs of the carrier will be delivered. This may be used by the investment division to monitor and manage the investment hedge relative to the product liability (the promises made to the product's policy holders).

If the investment division decide to use this system then the following two new data feeds will be required: a policy Administration Feed, with relevant information on each policy; this will include: equity-indexed crediting parameters, term, issue date; and an Investment Hedge Feed, with relevant information on the options and futures purchased/sold for each block of business.

These feeds will not be required for the initial product launch since a certain asset volume will be required before the Hedge Inventory System becomes useful. The record layout below deals only with the policy administration feed. This will involve a higher volume and will require automation. The investment feed will depend on what hedging strategy is implemented. It involves a much lower volume and can be handled via a simple spreadsheet input.

One record is required per policy. All fields should be based on current values as of the date that the file is created from the administration system. Input is freeform with fields separated by blanks or tabs. If it is possible for the data to be uniform (columnar) then this would be preferable, but not essential, for ease of input into the hedging system. The fields below are examples of the fields that will be required. The actual fields will be determined once the customization process begins.

The Product Type is a character code, such as BPA, identifying the product type. In some aspects, the policy number is an integer, such as 12345678, to uniquely identify the policy. The Starting Accumulation Value is a dollars and cents amount, such as 120000.00, which is the amount originally paid for the policy (the principal amount P). The Date of Issue is the date in YYYYMMDD format, such as 20030131, that the policy was issued. The Maturity Date is the date in YYYYMMDD format, such as 20330131, that an income is assumed to be paid under the terms of the policy. For this design it will be age 100 of the annuitant. The Owner Sex #1 is a single letter, one of M, F, or N (male, female, not a natural person) indicating the sex of owner #1 of the policy. This data may be required for calculation of the expected indexed interest credit on death. The Owner DOB #1 is the date in YYYYMMDD format, such as 19391015, that owner #1 of the policy was born. The Owner Sex #2 is a single letter, one of M, F, or N (male, female, not a natural person) indicating the sex of owner #1 of the policy. The Owner DOB #2 is the date in YYYYMMDD format, such as 19391015, that owner #2 of the policy was born. The Annuitant Sex #1 is a single letter, one of M, F, or N (male, female, not a natural person) indicating the sex of Annuitant #1 of the policy. This data may be required for calculation of the expected indexed interest credit on death. The Annuitant DOB #1 is the date in YYYYMMDD format, such as 19391015, that Annuitant #1 of the policy was born. The Annuitant Sex #2 is a single letter, one of M, F, or N (male, female, not a natural person) indicating the sex of Annuitant #1 of the policy. Annuitant DOB #2: This is the date in YYYYMMDD format, such as 19391015, that Annuitant #2 of the policy was born. The Term Period is an integer, such as 48, indicating the number of months in each term. The Index Type is a five character code, such as SP500 or NASDQ, identifying the outside index to which the performance of the policy is tied. The current Term has Calculation Factors. The Minimum Calculation Factors are separate factors needed for the second Term and the third Term. For each of these terms, the feed must show the guaranteed equity indexed allocation percentage, and the guaranteed declared rate. The Surrender Scale is a six character code, such as DECL06, identifying the Withdrawal Charge scale used for the policy. The Maximum Annual FPW Rate is a percentage, such as 10.00, indicating the maximum annual free partial withdrawal rate under the policy. The Last Update is the date in YYYYMMDD format, such as 20030131, when the values included in the extract file were last updated. It may be convenient for valuation dates to coincide with update dates. The Index Value at policy Issue is the value of the equity index, such as 850.00, that was in effect on the Date of Issue. The Minimum Guaranteed Contract Value at Issue is a dollars and cents amount, such as 108000.00, which is the Minimum Guaranteed Contract Value at issue. The Minimum Guaranteed Contract Value Interest Rate is the minimum guaranteed interest rate percentage to be credited to the Minimum Guaranteed Contract Value. The Accumulation Value at start of most recent policy year is a dollars and cents amount, such as 120000.00, which is the Accumulation Value at the start of the most recent policy year. The Minimum Guaranteed Contract Value at start of most recent policy year is a dollars and cents amount, such as 108000.00, which is the Minimum Guaranteed Contract Value at the start of the most recent policy year. The Index at start of most recent policy year is the value of the equity index, such as 850.00, that was in effect at the start of the most recent policy year. The Total Interest Credited is a dollar and cents amount, such as 10000.00, which is the total amount of interest ever credited to the policy. The Total Credits to the Minimum Guaranteed Contract Value is a dollar and cents amount, such as 10000.00, which is the total interest ever credited to the Minimum Guaranteed Contract Value. The Total FPW Deducted is a dollar and cents amount, such as 5000.00, which is the total amount of free partial withdrawals that have been deducted from the Accumulation Value.

At the start of each Term, the product can have indexing terms of 4 years, the accumulation value is given an equity indexed allocation and a Declared Rate allocation declared by the carrier.

In one embodiment, the equity indexed allocation has 100% participation in the S&P or another stock index (although other percentages, such as 80% or 120%, can be used and are within the spirit and scope of the claimed invention) until the earlier of the lock-in date or the end of initial term, while the Declared Rate allocation participates in declared rate crediting. The owner can request a lock-in once in each term. In each term, there is no credit until the earlier of the end of the term, or the date that the owner requests a lock-in. If the owner does not request a lock-in, then at the end of the term, he or she receives the combined total of 100% of the gain or loss in the index applied on the equity index allocation, plus the compounded declared rate earnings on the Declared Rate allocation, subject to a floor of zero. If the owner requests a lock-in prior to the end of the term, then at that time, the accumulation value (also referred to as account value) receives a pro-rata portion of the gain on the equity index allocation, plus the compounded declared rate earnings to date on the Declared Rate allocation. The accumulation value then earns guaranteed interest for the remainder of the term, using a rate determined at lock-in, as described below.

The Stock Index can be the S&P 500 Composite Price Index or another equity index. The Percentage Increase in S&P is calculated by comparing the Equity Index Ending Value for the lock-in date to the S&P index at the start of the term. At the end of the term, the Equity Index Ending Value is the average of the S&P 500 values during all business days during the last 30 calendar days of the term. On the date of death or lock-in prior to the end of the term, the Equity Index Ending Value is equal to the S&P Value on that day (or if that day not a business day, then on the previous business day in one embodiment, although other days such as the next business day can also be used and are within the spirit and scope of the claimed invention).

The Calculation Factors (equity-indexed crediting parameters) for each term are set by the carrier at the start of that term, and are guaranteed for the entire term. The Calculation Factors are: the Equity Indexed Allocation; the Declared Rate Allocation (equal to 100% minus the Equity Index Allocation); the Declared rate; and the Asset Expense Charge Rate.

The Equity Indexed Allocation is the proportion of the accumulation value (account value) for which earnings depend on the performance of the equity index up to end of the term, or the lock-in date if earlier. Pricing solves for a combination of Declared Rate allocation and equity indexed allocation that the carrier can credit while achieving target profitability. The Declared Rate Allocation is the proportion of the accumulation value for which earnings depend on the declared rate. The Declared Rate is the rate applied in the index credit calculation to the Declared Rate allocation. Renewal Calculation Factors apply to terms after the first. For each future term which begins before the end of the surrender charge period minimum Calculation Factors are guaranteed. An example of renewal Calculation Factors is 20% Equity Indexed Allocation, with a Declared rate of 1.5%, and an Asset Expense Charge Rate of 0%. Once in each term, the owner can elect to “lock-in” indexed gains at any time during that term. After the lock-in, the Accumulation Value (account value) earns daily interest for the rest of the term.

In determining the Index Credits (amount of interest to be credited), the carrier defines the following for time t, where t is the time since the start of the term: AVₜ is the Accumulation Value at time t, prior to any index credits; Aₜ is the Equity-Indexed Earnings, and is equal to: [the equity index allocation percentage] times [the percentage increase in the S&P (as defined above) at time t] times [the pro-rata factor for time t]; Bₜ is Declared Rate Earnings, and is equal to: [the Declared Rate allocation percentage] times [(1+Declared rate)^{t}−1]; Cₜ is the Death Benefit Rider Premium (also referred to as the rider charge), and is equal to: [the total annual premium rate for any riders attached to this policy] times [the number of years in the Elapsed Term for that date, or if less, the number of years between the start of the Term, and the Rider Premium Completion Date]; Dₜ is the Asset Expense Charge, and is equal to: [The asset expense charge rate] times [the number of years in the Elapsed Term for that date]. At any time t, the Index Earnings Factor equals the sum of: Aₜ+Bₜ−Cₜ−Dₜ, but not less than zero.

In some aspects, the pro-rata factor used in item A is defined to be: [the elapsed days since the start of the initial term] divided by [the total days in the initial term]. At any time t, if the owner has not elected lock-in for the current term, the Balanced Allocation Factor equals the sum of: Aₜ+Bₜ−Cₜ−Dₜ, but not less than zero. It is the same as the Index earnings factor except that the pro-rata factor is defined to be 1. If the owner has already elected lock-in, the Balanced Allocation Factor is zero.

If the owner does not elect lock-in, then the Accumulation Value (account value) receives an index credit (interest) at the end of the term equal to the Accumulation Value times the combined equity indexed gain or loss on the equity-allocation, and declared rate earnings on the Declared Rate allocation. The formula for the index credit is:

AV_{end of term} times the Index earnings factor. In the special case where the index credit is paid at the end of the term, the pro-rata factor is 1, and the Index earnings factor equals the sum of: A_{end of term}+B_{end of term}−C_{end of term}−D_{end of term}, but not less than zero.

If the owner elects lock-in at time t, then any equity index gains are locked in on the equity index allocation, and the accumulation value (account value) receives interest credited an immediately based on a pro-rata share of these equity index gains. As well, the accumulation value is credited with all declared rate earnings accrued to date on the declared rate portion. The formula is AVₜ times the Index earnings factor, where the Index earnings factor equals the sum of: Aₜ+Bₜ−Cₜ−Dₜ, but not less than zero.

Between the lock-in date and the end of the term, the accumulation value earns daily interest at the guaranteed rate (g) in the same way as an ordinary SPDA. The guaranteed rate (g) is calculated at the time of lock-in and ,is guaranteed for the remainder of the term.

The guaranteed rate is determined so that the end-of-term accumulation value will equal the accumulation value immediately prior to lock-in, plus the equity-indexed earnings (without any pro-rata adjustment) calculated at lock-in, plus declared rate earnings for the entire term.

In some aspects, the carrier solves for the guaranteed rate (g) such that the following formulas provide the same result, where RT is the time remaining in the term:

((AVₜ) (1+A_{end of term}+B_{end of term}−C_{end of term}−D_{end of term})), and

((AVₜ)(1+Aₜ+Bₜ−Cₜ−Dₜ)) ((1+g)^{RT})

Therefore (g) is equal to:

[(1+A_{end of term}+B_{end of term}−C_{end of term}−D_{end of term})]/[(1+Aₜ+Bₜ−Cₜ−Dₜ)]^{(1/RT)}−1]

In all cases the pro-rata factor used in the calculation equals the elapsed days since the start of the initial term; divided by the total days in the initial term.

The Accumulation Value (account value) at any time is equal to the Accumulation Value at the start of the term (or the premium [principal amount P] at the start of the first term), less withdrawals plus earnings. Before lock-in there are no increases to the Accumulation Value for that term. If the owner selects to lock-then, for that term, there is an immediate earnings credit to the Accumulation Value on the lock-in date. After lock-in the Accumulation Value earns daily interest at the guaranteed rate (g) for the remainder of that term. If there is no lock-in for a term, then any interest will be credited to the Accumulation Value at the end of that term.

The Cash Surrender Value is the greater of a) the Accumulation Value less surrender charge adjusted by market value adjustment (MVA); and b) the Minimum Guaranteed Contract Value. The Minimum Guaranteed Contract Value can be 87.5% of first year premium less withdrawals, all accumulated at X% interest, where X is between 1% and 3%. There is no Market Value Adjustment applied to the Minimum guaranteed value.

The Withdrawal Charge can be 13.5/13/12.5/12/11/10/9/8/7/6/5/3/0% of the amount withdrawn in excess of the free withdrawal amount for a 12-year design, and 10/9/8/7/6/5/4/3% of the amount withdrawn in excess of the free withdrawal amount for an 8-year design.

The market value adjustment applies during the Surrender Charge Period only. It is applied to the surrender value or partial withdrawal amount. However, it is not applied to free withdrawals.

The MVA is calculated as follows: (50%)(a−b−0.25%)(n/12), where: “a” is the 10-year Treasury Rate at the start of the term; “b” is the 10-year Treasury Rate on the calculation date; and “n” is the number of months remaining before the expiration of the surrender charge period. The MVA is limited as follows: a positive MVA cannot exceed the surrender charge, and a negative MVA cannot exceed the lifetime investment income to date.

In any policy year, the amount of cash received under a free withdrawal is limited to 10% of the Accumulation Value at the time of the first withdrawal in that year. Carrier practice is to use 10% of the accumulation value at the time of the first withdrawal, so that if an owner locks in part way through a year and receive index credits, the owner can then access 10% of the accumulation value including those index credits. The amount deducted from the Accumulation Value to pay for a free withdrawal equals the actual cash payment, divided by (1+Balanced Allocation Factor at time t). In other words, if the owner makes a withdrawal prior to lock-in, the owner receives the full in force gain on the amount deducted from the accumulation value.

There are also free withdrawals for confinement and terminal illness. For these free withdrawals, the amount deducted from the accumulation value will equal the amount paid to the owner divided by (1+Balanced Allocation Factor). No MVA or Surrender Charge applies to free withdrawals.

The death benefit is equal to the greater of the Cash Surrender Value at time of death (including any MVA), and the Balanced Allocation Value (with no MVA). The Balanced Allocation Value equals the Accumulation Value times (1+Balanced Allocation Factor).

Annuitization occurs on the maturity date. The maturity date is age 100 in one embodiment. The annuity value is the Cash Surrender Value. According to normal carrier practice, the Withdrawal Charges and MVA will be waived if the owner purchases a SPIA (single premium immediate annuity) within the following guidelines: in policy years 2-5 the SPIA must be for 8 years or longer; in policy years 6+ the SPIA must be for 5 years or longer.

Normal carrier definitions are used for confinement and terminal illness. The owner may deplete 100% of the Accumulation Value without incurring any Withdrawal Charges or MVA. Any withdrawal under either waiver is processed as a free partial withdrawal (i.e. it includes any gains to date). That means the owner will receive 100% of the Balanced Allocation Value if they deplete 100% of the Accumulation Value.

When a death benefit is paid, the beneficiary receives the greater of the basic death benefit under the annuity, and the Enhanced Guaranteed Minimum Death Benefit calculated on the same date as the regular death benefit, where the Enhanced Guaranteed Minimum Death Benefit is equal to the premium accumulated at the enhanced minimum death benefit rollup percentage of E% until the rider premium completion date, adjusted for withdrawals.

At issue, the Enhanced Guaranteed Minimum Death Benefit is equal to the premium. Thereafter, it increases daily at the Enhanced Guarantee Minimum Death Benefit Rate of E%, until the Enhanced Guarantee Minimum Completion Date. After that point, it no longer increases. The Enhanced Guaranteed Minimum Death Benefit is reduced on a pro-rata basis for partial withdrawals. For example, if 10% of accumulation value is withdrawn, then the Enhanced Guaranteed Minimum Death Benefit is reduced by 10%.

In one embodiment, the Enhanced Guarantee Minimum Death Benefit Completion Date is the anniversary following attained age 90. The annual rider premium is payable until the Rider Premium Completion Date. Although the Enhanced Guaranteed Minimum Death Benefit stops increasing after the Enhanced Guarantee Minimum Completion Date, it is still paid out if higher than the regular annuity death benefit.

In one embodiment, the rider premium is 0.50% per year, and it is charged at the same time that interest is credited to the accumulation value, although different premiums and timing of the charge are possible and are within the spirit and scope of the claimed invention.

If an owner does not elect lock-in during a term, then at the end of the term, the amount credited is reduced by the Accumulation value times 0.50% per year times the number of years in the term (or if less, the time between the start of the term and the Rider Premium Completion Date). However, the resulting credit cannot be less than zero. If an owner elects lock-in during a term, then at that time, the resulting credit is reduced by 0.50% times the number of full years plus a fraction for the partial year since the start of the term (or if less, the time between the start of the term and the Rider Premium Completion Date) As well, when calculating the guaranteed rate (g), the end-of-term benefit is reduced by the premium times the number of years in the term. The rider generally cannot be dropped after it is elected and premiums must be paid through the Rider Completion Date.

The plan can use a single-premium equity-indexed deferred annuity with a market value adjustment, and with guaranteed values calculated using a minimum guaranteed interest rate (called the Minimum Guaranteed Value Interest Rate) which can be specified. Additional interest can be credited to the policy based on performance. The Equity Index is as described in the policy form. The product contains a Lock-in feature, which allows the owner to “lock-in” their index performance-to-date on any one day prior to the end of each Indexing Term. The form provisions are in compliance with the Standard Nonforfeiture Law for Individual Deferred Annuities (SNFL), and the valuation methodology is in compliance the Standard Valuation Law (SVL).

The policy has a series of 4-year Indexing Terms. The first starts on the Issue Date. Each successive Indexing Term begins at the end of the previous Indexing Term. During each Indexing Term, the Accumulation Value for the policy is equal to the following: a) the Accumulation Value at the start of the Indexing Term (for the first Indexing Term this is the single premium minus premium taxes); plus b) Index Credits, which are credited on the earliest of i) the end of the Indexing Term ii) the lock-in date or ii) death; plus c) interest at a guaranteed rate (described below) for the time period (if any) between the lock-in date and the end of the Indexing Term; minus d) any amounts surrendered.

The surrender value of the contract is the greater of: the Accumulation Value, modified by any market value adjustment (MVA), less any surrender charge, and the Minimum Guaranteed Value (defined below). There is no MVA or Surrender Charge applied to the Minimum Guaranteed Value. The surrender charge schedule for any period can be less than or equal to the following:

Surrender Charge as % of Accumulation Value:

| Full or Partial Years | | |
|---|---|---|
| completed | Issue Ages 0-80 | Issue Ages 81-85 |
| 1 | 12% | 12% |
| 2 | 12% | 12% |
| 3 | 12% | 11% |
| 4 | 12% | 10% |
| 5 | 11% | 9% |
| 6 | 10% | 8% |
| 7 | 9% | 7% |
| 8 | 8% | 6% |
| 9 | 7% | 5% |
| 10 | 6% | 4% |
| 11 | 5% | 3% |
| 12 | 3% | 2% |
| 13+ | 0% | 0% |

The surrender charge can be waived on the first 10% of the Accumulation Value withdrawn in each policy year.

In some aspects, in each policy year, free partial withdrawals may be made totaling 10% of the year-start Accumulation Value. These free withdrawals receive the following special treatment: no Surrender Charge is applied; no MVA is applied; and the amount deducted from the Accumulation Value is less than the amount paid to the owner. It is equal to the amount paid to the owner divided by (1 plus the Modified Index Credit Factor, as described below).

In some aspects, the Minimum Guaranteed Value for the policy equals: the single premium paid by the owner (adjusted for premium taxes) multiplied by the Minimum Guaranteed Value Percentage; less any amounts surrendered; all accumulated at the Minimum Guaranteed Value Interest Rate. The Minimum Guaranteed Value Percentage will be at least 87.5%. The Minimum Guaranteed Value Interest Rate will be set at issue. It will at least be equal to: the average daily five-year Constant Maturity Treasury Rate as published by the Board of Governors of the Federal Reserve Board for the second full calendar month preceding the issue date; rounded to the nearest 0.05%, reduced by 1.25%, and reduced by a further R% during the first 4-year Indexing Term, to reflect equity participation (where R is between 0% and 1%). R is determined at issue and will not change thereafter, provided, however, that such resulting rate will be no greater than 3% nor less than 1%.

In some aspects, a Market Value Adjustment will be made to the Accumulation Value if part or all of the Accumulation Value is surrendered during the MVA Period. The MVA Period will be the same length as the surrender charge period. The Market Value Adjustment factor is equal to (0.50) (a−b−0.0025) (N/12) where:

(a) is the Treasury Constant Maturity Series rate (expressed as a decimal, e.g., 1%=0.01) for a t-year treasury bond, where t is the length of the MVA Period in years. For this purpose, the carrier uses the Treasury Constant Maturity Series for the week preceding the issue date.

(b) is the Treasury Constant Maturity Series rate (expressed as a decimal) for a t-year treasury bond, where t is the time remaining in the MVA Period, rounded up to the next number of years. For this purpose, the carrier uses the Treasury Constant Maturity Series for the week preceding the date of calculation.

(n) is the number of complete months from the date the Market Value Adjustment calculation is needed to the end of the MVA Period. If the number of years specified in “a” or “b” above is not equal to a maturity in the Treasury Constant Maturity Series, the Treasury MVA Rate will be determined by straight line interpolation between the interest rates of the next highest and next lowest maturities in the series.

For example, if the MVA Period is 8 years, the rate will be found by interpolating between the 7-year and 10-year rates. The one-year rate will be used for any time periods equal to or less than twelve (12) months. The amount of the Market Value Adjustment is equal to the market value adjustment factor multiplied by [(1)−(2)], where: (1)=the Accumulation Value for a Full Surrender or the amount for a Partial Surrender; (2)=the amount deducted from the Accumulation Value in respect of the Free Partial Withdrawal Provision.

If the owner has elected Lock-in for the current Indexing Term, then the Death Benefit can be equal to the Accumulation Value, which will have been credited with an Index Credit and fixed interest as described below. If the owner has not elected Lock-in, then the Death Benefit is equal to the Accumulation Value multiplied by one plus the Modified Index Credit Factor, as described below. However, in either case, the Death Benefit will be the Surrender Value if it is greater than the above-defined Death Benefit on the date of death of the Owner.

If the owner takes no action during the Indexing Term, then an Index Credit can be credited at the end of the Term, depending on the change in the Equity Index over the Indexing Term. The Accumulation Value receives no Index Credits in that Indexing Term prior to that date. However, owners can “lock in” any gains in the Equity Index prior to the end of the Term. The policy will no longer participate in any future increases or decreases in the Equity Index during that Indexing Term. In this case, the Accumulation Value will receive two types of interest credits: on the date they lock in (the Lock-in Date), it will receive an index credit reflecting declared rate credits and a pro-rata share of index gains or losses at that time; from that date until the end of the Indexing Term, it will earn daily interest at a fixed rate g, described below.

In some aspects, the Calculation Factors (equity-indexed crediting parameters) consist of the following: the Equity Indexed Allocation Percentage; the Equity Index Participation Rate; the Declared Rate Allocation Percentage (always equal to 100% minus the Equity Indexed Allocation Percentage); and the Declared Rate.

The Calculation Factors for the first Indexing Term are guaranteed for the first Indexing Term. The Calculation Factors for subsequent Indexing Terms will be declared at the start of those terms and will be guaranteed for those terms. For Indexing Terms ending during the surrender charge period, the Calculation Factors will not be less than the minimums determined in the policy.

For each Indexing Term, interest is first calculated and credited to the Accumulation Value (account value) on the Determination Date. For each Indexing Term, the Determination Date for that term is the earliest of a) the end of that Indexing Term, b) the date, if any, on which the owner elects lock-in for that Indexing Term, or c) the date of death, if it occurs during that Indexing Term.

On the Determination Date, the carrier calculates the Index Credit as the Accumulation Value at that time, times the Index Credit Factor. For any date on or after the Determination Date, The Index Credit Factor equals the sum of (a) below and (b) below: (a) is equal to the product of the following: the Equity Index Allocation Percentage; the Equity Index Change; the Equity Index Participation Rate; and the Pro-rata factor for that date. (b) is equal to the product of the following: the Declared Rate Allocation Percentage; and the value produced by compounding the declared rate for a period equal to the Elapsed Term as of that date. It is equal to (1+D)^{ET}−1, where D is the declared rate for the Indexing Term, and ET is the Elapsed term in years, i.e., the time since the start of the current Indexing Term. For this purpose, the Equity Index Change equals:

the Equity Index Ending Value on the Determination Date (which may be earlier than the current date), minus the value of the Equity Index on the first day of the Indexing Term; divided by the Equity Index Value on the first day of the Indexing Term.

The Equity Index Ending Value is calculated as follows: if the Determination Date is the last day of an Indexing Term, the Equity Index Ending Value equals the arithmetic average of the values of the Equity Index on each business day during the last 30 calendar days of the Term; and if the Determination Date is not the last day of an Indexing Term, the Equity Index Ending Value equals the value of the Equity Index for that date. The Pro-rata factor for any date equals the proportion of the Indexing Term that has passed.

In some aspects, if an owner locks in prior to the end of the Indexing Term, the carrier calculates a Guaranteed Rate g on that date, and then credits daily interest to the Accumulation Value for the rest of the Indexing Term at that annual effective rate. The carrier calculates the Guaranteed Rate g so that, if no withdrawals are made, the Accumulation Value at the end of the Indexing Term will be equal to the Accumulation Value immediately prior to lock-in times (1+the Index Credit Factor for the last day of the Indexing Term). The formula for g is [(1+ICFₜₑᵣₘ)/(1+ICF_{dd})]^{(1/n)}−1, where: ICFₜₑᵣₘ is the Index Credit Factor for the last day of the Indexing Term, ICF_{dd} is the Index Credit Factor on the Determination Date, and (n) is the time remaining in the Indexing Term.

The Modified Index Credit Factor is used for Death Benefits and free partial withdrawals. It is calculated in the same way as the regular Index Credit Factor except that item (a) does not have the pro-rata factor applied.

Example of credits during Indexing Term with no Lock-in. This example shows the Index Credit at the end of the first Indexing Term, assuming the owner does not elect a lock-in during the Term. Assume the Calculation Factors for the first Indexing Term are as follows: 1. The Equity Indexed Allocation Percentage is 40%. 2. The Equity Index Participation Rate is 100%. 3. The Declared Rate Allocation Percentage is 60%; and 4. The Declared Rate is 2.50%. Also assume the following: The premium is $10,000; no withdrawals occur during the Indexing Term; the Stock index is 1,000 at issue. The Average Stock Index during the last 30 days of the Indexing Term is 1,300.

Then, the carrier calculates item (a) of the Index Credit Factor as follows: The pro-rata factor is 100%, since 100% of the Indexing Term has passed. The Average Index Value is 1,300. The Equity Index Change is (1,300−1,000)/1,000, or 30%. Therefore, item (a) equals the product of: 40% (the Equity Index Allocation Percentage); 30% (the Equity Index Change); 100% (the Equity Index Participation Rate); and 100% (the Pro-rata factor for that date); the product is 12%.

As well, the carrier calculates item (b) as the product of the following: 60% (the Declared Rate Allocation Percentage); and (1.0250)⁴−1. The product is 6.229%. Therefore, the Index Credit Factor is 12%+6.229%, or 18.229%. The Index Credit is thus 10,000 times 18.229%, or 1,822.90. This is added to the Accumulation Value, which becomes 11,822.90.

This example shows the Index Credit during the first Indexing Term, assuming the owner elects lock-in mid way through the third year. Assume that the stock index is 1200 in the middle of the third year. Assume the Calculation Factors and other assumptions are the same as in the previous subsection. Then the Index Credit Factor at time 2.5 is calculated as follows:

Item (a) equals the product of: 40% (the Equity Index Allocation Percentage); 20% (the Equity Index Change); 100% (the Equity Index Participation Rate); and 62.5% (the Pro-rata factor for that date); the product is 5%.

Item (b) is the product of the following: 60% (the Declared Rate Allocation Percentage); and (1.025)^{2.5}−1; the product is 3.821%.

Therefore, the Index Credit Factor is 5%+3.821%, or 8.821%. At the time of Lock-in, the carrier also calculates the Index Credit Factor for the end of the Indexing Term. In this case, item (a) equals the product of: 40% (the Equity Index Allocation Percentage); 20% (the Equity Index Change); 100% (the Equity Index Participation Rate); and 100% (the Pro-rata factor for that date); the product is 8%.

Item (b) as the product of the following: 60% (the Declared Rate Allocation Percentage); and (1.025)⁴−1; the product is 6.229%.

Therefore, the Index Credit Factor is 8%+6.229%, or 14.229%. Therefore, the carrier calculates the guaranteed rate g as: (1.14229/1.08821)^{1/15}−1, or 3.286%. Therefore, if the owner locks in after 2.5 years, the Accumulation Value gets an immediate index credit of 8.821%, or $882.10. As well, it earns daily interest for the remaining 1.5 years at an annual effective rate of 3.286%.

Section 4 of the nonforfeiture law defines the “minimum nonforfeiture amount”. The Minimum Guaranteed Value under this policy is always equal to or greater than the “minimum nonforfeiture amount” because: a) it is based on 87.5% or more of premium, which is the same or greater than the minimum requirement of 87.5%; and b) it does not apply any of the charges allowed for in the calculation of the required minimum nonforfeiture amount; and c) it will grow at an interest rate which is the same or greater than the minimum requirement in the state where it is issued.

Item c) needs further explanation. After the end of the first 4-year Indexing Term, this interest rate will equal: the monthly average five-year constant maturity treasury rate as published by the Board of Governors of the Federal Reserve Board for the second full calendar month preceding the issue date; rounded to the nearest .05%; and reduced by 1.25%; provided, however, that such resulting rate will be no greater than 3% nor less than 1%. This rate is compliance with the nonforfeiture law, and will not be modified after issue.

During the first Term only, the carrier intends to make an additional reduction of R, as permitted for equity-indexed annuities. Again, the resulting rate can be no greater than 3% nor less than 1%. According to the draft Annuity Nonforfeiture Model Regulation, the additional reduction R must be the lesser of 1.00% or the annualized option cost.

At launch, a carrier intend to offer the following Calculation Factors: Equity Indexed Allocation Percentage of 40%; Equity Index Participation Rate of 100%; Declared Rate Allocation Percentage of 60%; and Declared Rate of 2.50%.

As discussed below, the cost of the option which hedges the equity participation is approximately 10% of the premium given current economic conditions. Therefore, the annualized cost is roughly 2.50%. Therefore the carrier can utilize the maximum 1.00% reduction. At its discretion, the carrier may choose to utilize a reduction less than 1.00% when issuing the policy.

For example, if the 5-year CMT used for setting the rate is 3.90%, then the interest rate prior to the reduction R will be 3.90% −1.25%, or 2.65%. During the Indexing Term, the carrier may deduct another 1.00%, so the rate can be as low as 1.65%. However, the carrier may decide not to deduct the full 1.00%. For example, the carrier may decide to launch with a rate of 2.05% for the first Indexing Term. In this case, the Minimum Guaranteed Value Interest Rate would be 2.05% for the first four policy years, and 2.65% thereafter.

For future policies, the carrier can monitor the annualized option cost for the initial Indexing Term, and use a lower reduction than 1.00% for those policies if required. The carrier can show compliance with the retrospective test for minimum nonforfeiture rates of both 1% and 3%, assuming a Minimum Guaranteed Value Percentage of 87.5%. From time-to-time, the carrier may issue policies with a Minimum Guaranteed Value Percentage greater than 87.5%; this will result in even greater guaranteed values in column (1) and therefore a greater value in the Difference column.

Section 6 of the nonforfeiture law says that the cash surrender value benefit can never be less than the present value at (i+1%) of the maturity benefit on a guaranteed basis, where i is the interest rate used to accumulate the premium. During the Indexing Term, prior to the lock-in date, the policy performance is subject to the performance of the underlying Equity Index. Since the underlying Equity Index is not guaranteed, the performance of the policy is also not guaranteed, and it is possible that the Minimum Guaranteed Value will drive the policy. Therefore, (i) is equal to the Minimum Guaranteed Value Interest Rate, which will be between 1% and 3%.

During the Indexing Term, after the lock-in date, the policy earns a fixed rate g. During this time period, the rate (i) is equal to the rate g. In the example above, (g) was 3.286%. The actual value of (g) will depend on the Calculation Factors, index performance and the time of lock in.

In some aspects, if the owner never locks in, then the guaranteed rate will be between 1% and 3%. For issue ages up to 80, Table 4 below shows that the surrender charges under the policy satisfy section 6 of the nonforfeiture law, since the value of (1−surrender charge) exceeds the required surrender value, whether g is 1% or 3%. For this purpose, the surrender charges reflect the ability to withdraw 10% of the Accumulation Value without a surrender charge. The table below shows compliance for issue age 80, where the maturity date is 20 years later than the issue date. Younger issue ages also comply with the prospective test since the surrender charge scale is the same as for issue age 80, but ends earlier relative to the maturity date.

| Years | | | | Pass? |
|---|---|---|---|---|
| Prior to | (1.01^{t})/ | | | (Col 4 >= Max |
| Maturity | (1.02^{t}) | (1.03^{t})/(1.04^{t}) | 1-Surrender | (Col 2, |
| Date (t) | (for i = 1%) | (for i = 3%) | Charge | Col 3)) |
| 20 | 82.12 | 82.43 | 89.20 | YES |
| 19 | 82.93 | 83.23 | 89.20 | YES |
| 18 | 83.75 | 84.04 | 89.20 | YES |
| 17 | 84.58 | 84.85 | 89.20 | YES |
| 16 | 85.42 | 85.68 | 89.20 | YES |
| 15 | 86.26 | 86.51 | 90.10 | YES |
| 14 | 87.12 | 87.35 | 91.00 | YES |
| 13 | 87.98 | 88.20 | 91.90 | YES |
| 12 | 88.85 | 89.05 | 92.80 | YES |
| 11 | 89.73 | 89.92 | 93.70 | YES |
| 10 | 90.62 | 90.79 | 94.60 | YES |
| 9 | 91.51 | 91.67 | 95.50 | YES |
| 8 | 92.42 | 92.56 | 97.30 | YES |
| 7 | 93.34 | 93.46 | 100.00 | YES |
| 6 | 94.26 | 94.37 | 100.00 | YES |
| 5 | 95.19 | 95.28 | 100.00 | YES |
| 4 | 96.14 | 96.21 | 100.00 | YES |
| 3 | 97.09 | 97.14 | 100.00 | YES |
| 2 | 98.05 | 98.09 | 100.00 | YES |
| 1 | 99.02 | 99.04 | 100.00 | YES |
| 0 | 100.00 | 100.00 | 100.00 | YES |

For issue ages up 81-85, the table below shows that the surrender charges under the policy satisfy section 6 of the nonforfeiture law, since the value of (1−surrender charge) exceeds the required surrender value, whether g is 1% or 3%. The table shows compliance for issue ages 85, where the maturity date is 15 years later than the issue date. Issue ages 81-84 also comply with the prospective test since the surrender charge scale is the same as for issue age 85, but ends earlier relative to the maturity date.

| Years | | | | Pass? |
|---|---|---|---|---|
| Prior to | (1.01^{t})/ | | | (Col 4 >= Max |
| Maturity | (1.02^{t}) | (1.03^{t})/(1.04^{t}) | 1-Surrender | (Col 2, |
| Date (t) | (for i = 1%) | (for i = 3%) | Charge | Col 3)) |
| 15 | 86.26 | 86.51 | 89.20 | YES |
| 14 | 87.12 | 87.35 | 89.20 | YES |
| 13 | 87.98 | 88.20 | 89.20 | YES |
| 12 | 88.85 | 89.05 | 90.10 | YES |
| 11 | 89.73 | 89.92 | 91.00 | YES |
| 10 | 90.62 | 90.79 | 91.90 | YES |
| 9 | 91.51 | 91.67 | 92.80 | YES |
| 8 | 92.42 | 92.56 | 93.70 | YES |
| 7 | 93.34 | 93.46 | 94.60 | YES |
| 6 | 94.26 | 94.37 | 95.50 | YES |
| 5 | 95.19 | 95.28 | 96.40 | YES |
| 4 | 96.14 | 96.21 | 97.30 | YES |
| 3 | 97.09 | 97.14 | 98.20 | YES |
| 2 | 98.05 | 98.09 | 100.00 | YES |
| 1 | 99.02 | 99.04 | 100.00 | YES |
| 0 | 100.00 | 100.00 | 100.00 | YES |

The above two tables show that the an interest rate of 3% produces higher required nonforfeiture values than an interest rate of 1%. Therefore, the rest of this analysis will use an interest rate of 3% prior to any lock-in. But it should be understood that the interest rates can be other values.

Impact of Lock-in: the above table shows that without lock-in, the policy passes section 6 for i between 1% and 3%. However, lock-in can produce much higher rates for i. Testing confirms that the product still passes the test even if the owner locks in at the end of year 1, 2, or 3 during each Indexing Term.

The Minimum Guaranteed Value available at any time other than a contract anniversary is calculated with allowance for the lapse of time at the Minimum Guaranteed Value Interest Rate.

In some aspects, the valuation methodology is as follows the plan is a Type B annuity, since funds can only be withdrawn subject to an MVA prior to the end of the rate guarantee period. There is no rate guarantee on future considerations. The carrier can value this policy on the issue-year basis. The appropriate Type B rate for 2005 is 4.75%. Death Benefits are valued using the Type A rate for 2005 of 5.25%. These rates will change for new issues depending on the year of issue.

The valuation methodology will follow Actuarial Guideline 35. The computational method used will be based on the Commissioners Annuity Reserve Method with Updated Market Values (“CARVM-UMV”) method. A description of the CARVM-UMV is as follows: Step 1: For each duration and each benefit, at which an index-based benefit is available, determine the market value of the appropriate call option. The appropriate call option is one that exactly hedges the floor of the benefit at that point in time. This means that the payoff of the call option should exactly equal the difference between the specific benefit available at that point in time (reflecting all relevant contract features) and the guaranteed floor of that benefit. The market value should be determined using an appropriate option pricing technique, such as the Black Scholes formula or a stochastic scenario method. Step 2: The market value of all the call options are projected forward at the appropriate valuation interest rate to the point in time at which the option would expire. The interest rate should be consistent with the requirements of any applicable Actuarial Guidelines or regulations, such as Actuarial Guideline 33 or Actuarial Guideline 9-B. Step 3: The future guaranteed benefits for each benefit at each point are determined by adding the guaranteed floors of the benefit to the amounts determined in step 2. Step 4: Now a CARVM Calculation can be performed. The CARVM calculation should be in accordance with Actuarial Guideline 33 and any other applicable regulations or Actuarial Guidelines.

The above methodology works very well for a product where there is only one index-based payoff over the life of the policy. However, it is not as straightforward when there is more than one payoff For example, suppose you want to buy an option to hedge the guaranteed surrender benefit at the end of year 5, for this product, as of the issue date. Then you would need a single option which makes a payout at the end of 4-year Indexing Term based on the first term's Calculation Factors, and then makes an additional payout at the end of year 5 taking into account the payout at the end of year 4, and reflecting the guaranteed Calculation Factors for the second term.

Rather than determining the price of several such options, the carrier substantially reproduces the result by projecting options separately for each Indexing Term and then compounding the results. The next several sections describe how future values are projected under the requirements of the CARVM-UMV. Because the calculations are quite time consuming, the actual valuation of policies may use reasonable approximations.

Step 1—Estimation of Option Values-This section shows how option values are estimated. All numbers in this example are hypothetical; the actual option cost parameters and Calculation Factors will be determined by current economic conditions. Assumptions: Assume the issue age is 55; Assume the Type B valuation rate is 4.75%, and the Type A valuation rate is 5.25%; Assume the policy is sold with the following features: S&P Index is 1000 at issue; Single Premium is $10,000; Minimum Guaranteed Value Interest Rate is 2.05% for the first 4 years and 2.65% thereafter.

Assume the Calculation Factors for the first Indexing Term are as follows: the Equity Indexed Allocation Percentage is 40%; the Equity Index Participation Rate is 100%; the Declared Rate Allocation Percentage is 60%; and the Declared Rate is 2.50%.

Assume the Guaranteed Calculation Factors at issue, for the second and third Indexing Terms are as follows: the Equity Indexed Allocation Percentage is 20%; the Equity Index Participation Rate is 100%; the Declared Rate Allocation Percentage is 80%; and the Declared Rate is 1.50%.

According to Actuarial Guideline 35, option costs can be calculated using “an appropriate option pricing technique, such as Black-Scholes or a stochastic scenario method”. These sample calculations assume that the carrier calculates option costs using a method consistent with Black-Scholes, except than any options which hedge the benefit at the end of the Indexing Term reflect the 30-day averaging at that time.

The Black-Scholes option cost parameters are: S=the current value of the stock index; E=the exercise value of the stock index (also known as the strike price). This is the minimum value of the equity index that will result in a payoff from the option; t, the time remaining until the payoff; sigma, the implied volatility; r, the continuous risk-free interest rate for the time period equal to t; and d, the continuous dividend yield.

The value of S at issue is assumed to be 1,000 as stated above. The value of E is a function of the Calculation Factors as described below. Assume that sigma is 20%. Assume the dividend yield is 1.5% annually, or 1.44886% continuously compounded. Assume that the risk free rate is 4%. The continuous risk free rate is then 3.9221%.

For the Surrender Benefit, costs are developed based on the Index Credit Factor (the cost calculation assumes that owners lock-in prior to surrender, since this produces higher cash value than if they fail to lock-in); for the Death Benefit, costs are developed based on the Modified Index Credit Factor; and for policies which elect Lock-in and remain in force, costs are developed based on the Index Credit Factor at the end of the Indexing Term.

We estimate the cost of hedging options for regular Index Credits as follows. Let us first look at the option which hedges the regular index credits, which are used to calculate the surrender value at the end of year 1, assuming owners lock-in prior to surrender.

First, the exercise price of the option is determined as follows: The index credit factor is equal to the sum of (a) and (b) but not less than zero, where (a) and (b) are as in the description of the Index Credit Factor. At the end of year 1, Item (b) is equal to 60%×2.50%, or 1.50%.

The secondary guarantee (the Minimum Guaranteed Value) at the end of year 1 is only 89.29% of premium. Therefore it does not come into play here. In order for the Accumulation Value to exceed the premium, item (a) plus item (b) must equal or exceed zero. Therefore item (a) must equal or exceed −1.50%. This means that the value of the equity index percentage change must be −15% or greater (since −15%, times the 100% participation rate, times the 40% Equity Indexed Allocation, times the 25% pro-rata factor is −1.50%).

In other words, the Index Credit Factor is positive if the value of the Equity Index at the end of year 1 is equal to 85% of the starting value, or greater. Next the carrier determines the price of the option to hedge $1: Using the assumptions above, the cost of a one-year option with an exercise price of 85% of the initial index is 18.478% of the amount covered. Next the carrier determines how many options to buy: In this case, the equity-indexed portion of the payoff is multiplied by 40% (to reflect the Equity Index Allocation Percentage) and also by 25% (to reflect the pro-rata factor). So the notional amount of the option is 10% of the premium. Finally, the carrier determines the cost of the option as 18.478% times 10%, or 1.848%.

The value of the hedging option for future Indexing Terms is estimated as follows. Accumulate all option growth to the start of the current Indexing Term at the risk-free rate. Use this to estimate the Accumulation Value at the start of the Indexing Term on a risk-neutral basis (i.e. on a basis consistent with the Black-Scholes formula). Add the impact of any options which hedge benefits within the current Indexing Term. Discount to the valuation date using the risk-free rate (again consistent with the Black-Scholes formula).

Estimate Cost of Hedging Options for Modified Index Credits—Now let us look at the option which hedges the modified index credit at the end of year 1. The modified index credit is used for deaths and partial withdrawals. First, the exercise price is determined as follows: The modified index factor is equal to the sum of (a) and (b) but not less than zero, but this time the pro-rata factor is not applied to (a). At the end of year 1, Item (b) is equal to 60%×2.50%, or 1.50%. In order for the Accumulation Value to exceed the premium, item (a) must equal or exceed −1.50% of premium. This means that the value of the equity index percentage change must be −3.75% or greater (since −3.75%, times the 100% participation rate, times the 40% Equity Indexed Allocation is −1.50%).

In other words, the Index Credit Factor is positive if the value of the Equity Index at the end of year 1 is equal to 96.25% of the starting value, or greater. Next the carrier determines the price of the option to hedge $1. Using the assumptions above, the cost of a one-year option with an exercise price of 96.25%, is 10.965% of the amount covered. Next the carrier determines how many options to buy. In this case, the equity-indexed portion of the payoff is multiplied by 40% (to reflect the Equity Index Allocation Percentage). So the notional is 40% of the premium. Finally, the carrier determines the cost of the option as 10.965% times 40%, or 4.386%.

The value of the hedging option for future Indexing Terms can be estimated in much the same way as described in the previous section. We estimate the cost of hedging options for the Lock-in benefit as follows. Now let us look at the option which hedges the benefit to the owner if they lock-in at the end of year 1, but do not surrender the policy. First, the exercise price of the option is determined as follows: The index factor at the end of the term is equal to the sum of (a) and (b) but not less than zero. The value of Item (b) at the end of the Indexing Term is equal to 60%×1.025⁴−1, or 6.23%. In order for the Accumulation Value to exceed the premium, item (a) at the time of lock-in must equal or exceed −6.23% of premium. This means that the value of the equity index percentage change (as described on page 5) must be −15.575% or greater (since −15.575%, times the 100% participation rate, times the 40% Equity Indexed Allocation is −6.23%). In other words, the Index Credit Factor is positive if the value of the Equity Index at the end of year 1 is equal to 84.43% of the starting value, or greater.

Next the carrier determines the price of the option to hedge $1. Using the assumptions above, the cost of a one-year option with an exercise price of 84.43%, is 18.918% of the amount covered. Next the carrier determines how many options to buy. In this case, the equity-indexed portion of the payoff is multiplied by 40% (to reflect the Equity Indexed Allocation Percentage). So the notional for the option is 40% of the premium. Finally, the carrier determines the cost of the option. The cost is 18.918% times 40%, or 7.567%. The value of the hedging option for future Indexing Terms can be estimated as in the previous section.

Steps 2 and 3 involve accumulating option costs at the valuation rate and projecting benefits. The option values are accumulated using the Type B valuation rate to project future surrender benefits, partial withdrawal benefits, and lock-in benefits. They are accumulated at the Type A valuation rate to project future death benefits. At the end of each Indexing Term, the death benefit and Accumulation Value are the same.

Step 4 is the CARVM calculation. Now that the carrier can project future benefits, the carrier can use them to calculate the reserve. This section shows how the reserve is calculated at issue for a male age 55 at issue.

Step 1. Assume no free partial withdrawals (See table below):

| | | | | PV | | |
|---|---|---|---|---|---|---|
| | | | | Through | | |
| | | | PV | Future | PV of | |
| | | | Through | Date | Full | |
| | | | Future | of Free | Surrender | |
| | | | Date of | Partial | on the | |
| Future | Mortality | | Death | With- | Future | |
| Date | Rate | In Force | Benefit | drawals | Date | Total |
| 0 | | 1.000000 | 0.00 | 0.00 | 8920.00 | 8920.00 |
| 1 | 0.00453 | 0.99547 | 45.07 | 0.00 | 8660.03 | 8705.10 |
| 2 | 0.00488 | 0.99061 | 92.20 | 0.00 | 8453.94 | 8546.15 |
| 3 | 0.00523 | 0.98543 | 141.24 | 0.00 | 8300.21 | 8441.46 |
| 4 | 0.00559 | 0.97992 | 192.09 | 0.00 | 8283.77 | 8475.86 |
| 5 | 0.00599 | 0.97405 | 244.98 | 0.00 | 8064.78 | 8309.76 |
| 6 | 0.00643 | 0.96779 | 299.24 | 0.00 | 7861.76 | 8161.00 |
| 7 | 0.00693 | 0.96108 | 355.28 | 0.00 | 7692.80 | 8048.08 |
| 8 | 0.00752 | 0.95386 | 414.44 | 0.00 | 7545.85 | 7960.29 |
| 9 | 0.00821 | 0.94602 | 477.18 | 0.00 | 7333.59 | 7810.77 |
| 10 | 0.00901 | 0.93750 | 542.91 | 0.00 | 7134.20 | 7677.10 |
| 11 | 0.00994 | 0.92818 | 612.25 | 0.00 | 7027.37 | 7639.63 |
| 12 | 0.01102 | 0.91796 | 686.95 | 0.00 | 6998.12 | 7685.07 |

Step 2 Assume Maximum free partial withdrawals (See table below):

| | | | | PV | | |
|---|---|---|---|---|---|---|
| | | | | Through | | |
| | | | PV | Future | PV of | |
| | | | Through | Date | Full | |
| | | | Future | of Free | Surrender | |
| | | | Date of | Partial | on the | |
| Future | Mortality | | Death | With- | Future | |
| Date | Rate | In Force | Benefit | drawals | Date | Total |
| 0 | | 1.000000 | 0.00 | 0.00 | 8920.00 | 8920.00 |
| 1 | 0.00453 | 0.99547 | 45.07 | 950.33 | 7709.71 | 8705.10 |
| 2 | 0.00488 | 0.99061 | 87.70 | 1766.82 | 6829.19 | 8683.71 |
| 3 | 0.00523 | 0.98543 | 127.92 | 2470.08 | 6105.12 | 8703.13 |
| 4 | 0.00559 | 0.97992 | 165.85 | 3155.84 | 5492.87 | 8814.55 |
| 5 | 0.00599 | 0.97405 | 201.36 | 3741.50 | 4828.09 | 8770.94 |
| 6 | 0.00643 | 0.96779 | 234.23 | 4242.93 | 4262.27 | 8739.43 |
| 7 | 0.00693 | 0.96108 | 264.92 | 4672.52 | 3782.83 | 8720.27 |
| 8 | 0.00752 | 0.95386 | 294.23 | 5071.59 | 3340.19 | 8706.01 |
| 9 | 0.00821 | 0.94602 | 322.21 | 5411.65 | 2930.61 | 8664.47 |
| 10 | 0.00901 | 0.93750 | 348.68 | 5702.07 | 2581.89 | 8632.64 |
| 11 | 0.00994 | 0.92818 | 373.91 | 5950.19 | 2309.20 | 8633.29 |
| 12 | 0.01102 | 0.91796 | 396.11 | 6180.96 | 2076.95 | 8654.02 |

The reserve is the greater of the largest present value from step 1 and step 2; in this example, it $8,920.00.

The owner may elect the Enhanced Guaranteed Minimum Death Benefit rider. Under this rider, the death benefit is the greater of the basic annuity death benefit, or the Enhanced Guaranteed Minimum Death Benefit. The Enhanced Guaranteed Minimum Death Benefit is equal to the annuity single premium accumulated at E% interest (the enhanced minimum death benefit rollup percentage) up to Age Y. The Enhanced Guaranteed Minimum Death Benefit does not increase after age Y. In the policy form X is called the Enhanced Guaranteed Minimum Death Benefit Rate, and Y is called the Enhanced Guaranteed Minimum Death Benefit Completion Date. At filing, the carrier may launch with X=5% and Y=Age 90. Any partial withdrawals from the policy reduce the Enhanced Guaranteed Minimum Death Benefit on a pro-rata basis.

The rider impacts policy benefits as follows: Rider Premium—The annual rider premium will be P%. It will be payable through the Rider Premium Completion Date. At launch the annual premium may be 0.50% through age 90. The rider premium is only deducted from Indexing Term Interest, but can never make the Indexing Term Interest less than zero. Stated another way, the amount of charge deducted at any time will be limited to the amount of the Index Credit.

The rider premium is implemented by reducing Index Credit Factors by the rider premium times the number of years elapsed since the start of the Indexing Term. However, the resulting Index Credit Factor still can not be less than zero. If there were a rider premium of 0.50%, the examples from earlier in this demonstration would be impacted as follows: in the first example in this memorandum, where there is no Lock-in, then the Index Credit Factor at the end of the Indexing Term is 18.289%. If there is a rider premium of 0.50%, then the Index Credit Factor is reduced by 0.50%×4, or 2.00%. The resulting Index Credit Factor is 16.289%.

In the second example, the Index Credit Factor at the time of lock-in is 8.821%. If there is a rider premium of 0.50%, then the Index Credit Factor is reduced by 0.50%×2.5, or 1.25%. The resulting Index Credit Factor is 7.571%. In the same example, the Index Credit Factor at the end of the Indexing Term is 14.229%. If there is a rider premium of 0.50%, then Index Credit Factor is reduced by 0.50%×4, or 2.00%. The resulting Index Credit Factor is 12.229%. The resulting value of g is (1.12229/1.07571)^{1/1.5}−1, or 2.866%.

The Death Benefit paid is the greater of the regular Death Benefit or the Enhanced Guaranteed Minimum Death Benefit. For example, assume an owner pays a single premium of $10,000 at age 55, and makes no withdrawals, and the Enhanced Guaranteed Minimum Death Benefit Rate is 5% per year. Then at age 90, the Enhanced Guaranteed Minimum Death Benefit is $10,000×1.0535, or $55,160.15. Therefore the death benefit at age 90 and later will be at least $55,160.15, regardless of the actual performance of the Equity Index. For policies with the rider, reserves are impacted in two ways: projected Death Benefits are higher, and other projected benefits are lower.

The hedging options used to project future Accumulation Values are modified to reflect the rider charge, as follows: for surrender benefits, item (b) is −1.50% at the end of year 1, so item (a) must be at least −1.50%. However, if the carrier introduces a rider premium of 0.5%, then in order for there to be an index credit, item (a) must be at least −1.00%. This means that the value of the equity index percentage change must be −10.00% or greater (since −10%, times the 100% participation rate, times the 40% Equity Indexed Allocation Percentage, times the 25% pro-rata factor is −1.00%).

In other words, the Index Credit Factor is positive if the value of the Equity Index is equal to 90% of the starting value, or greater (as opposed to 85% or greater without the rider). Next the carrier determines the price of the option to hedge $1. Using the assumptions above, the cost of a one-year option with an exercise price of 90% is 14.852% of the amount covered. Next the carrier determines how many options to buy. In this case, the equity-indexed portion of the payoff is multiplied by 40% (to reflect the Equity Index Allocation Percentage) and also by 25% (to reflect the pro-rata factor). So the notional amount is 10% of the premium. Finally, the carrier determines the cost of the option. The cost is 14.852% times 10%, or 1.485%, compared to 1.848% without the death benefit rider.

The lower option cost results in a lower projected payout for the surrender benefits, free withdrawal benefits, and lock-in benefits, as would be expected due to the imposition of a rider charge.

The options used to project the death benefit must reflect the impact of the Enhanced Guaranteed Minimum Death Benefit. For example, let us look at the death benefit at time 1. With the rider, it has a guaranteed value of 105% of premium. However, it can be higher than 105% if the stock index grows sufficiently. As before, the value of item (b) at the end of year 1 is 1.50%. In order for the death benefit to be greater than 105%, item (a) must be at least +4% (as opposed to minus 1.5% without the rider), since 100%+4% +1.50% −0.50% rider charge=105%. In order for item (a) to be 4%, the stock index must go up by at least 10% (since 10%, times the 100% participation rate, times the 40% Equity Indexed Allocation Percentage, times the 100% pro-rata factor for death benefits, is 4%). Therefore, the strike price is 110% of the initial index.

Using the assumptions above, the cost of a 1-year option with an exercise price of 110% of the initial index is 5.018% of the amount covered. However, since the equity indexed allocation percentage is only 40%, the final cost is 2.007%. If the carrier accumulates this to the end of year 1 at the assumed Type A rate of 5.25%, then the expected option payout is 2.11%. As a result, the expected death benefit is 105%+2.11%, or 107.11%. By contrast, without the rider, the expected death benefit is 104.62%.

Now that the carrier can calculate the benefits, the carrier can calculate reserves. The tables below show the calculation of CARVM reserves. They are the same as the previous reserve calculation tables, other than reflecting rider charges and benefits.

Step 1. Assume no free partial withdrawals (See table below):

| | | | | PV | | |
|---|---|---|---|---|---|---|
| | | | | Through | | |
| | | | PV | Future | PV of | |
| | | | Through | Date | Full | |
| | | | Future | of Free | Surrender | |
| | | | Date of | Partial | on the | |
| Future | Mortality | | Death | With- | Future | |
| Date | Rate | In Force | Benefit | drawals | Date | Total |
| 0 | | 1.000000 | 0.00 | 0.00 | 8920.00 | 8920.00 |
| 1 | 0.00453 | 0.99547 | 46.17 | 0.00 | 8629.07 | 8675.23 |
| 2 | 0.00488 | 0.99061 | 95.02 | 0.00 | 8398.76 | 8493.78 |
| 3 | 0.00523 | 0.98543 | 148.16 | 0.00 | 8223.46 | 8371.63 |
| 4 | 0.00559 | 0.97992 | 204.84 | 0.00 | 8181.95 | 8386.78 |
| 5 | 0.00599 | 0.97405 | 263.60 | 0.00 | 7931.78 | 8195.38 |
| 6 | 0.00643 | 0.96779 | 326.49 | 0.00 | 7710.07 | 8036.56 |
| 7 | 0.00693 | 0.96108 | 394.15 | 0.00 | 7515.84 | 7909.98 |
| 8 | 0.00752 | 0.95386 | 467.35 | 0.00 | 7346.11 | 7813.47 |
| 9 | 0.00821 | 0.94602 | 547.10 | 0.00 | 7107.85 | 7654.95 |
| 10 | 0.00901 | 0.93750 | 634.41 | 0.00 | 6893.98 | 7528.39 |
| 11 | 0.00994 | 0.92818 | 730.49 | 0.00 | 6766.09 | 8530.07 |
| 12 | 0.01102 | 0.91796 | 836.65 | 0.00 | 6711.67 | 7548.32 |

Step 2. Assume Maximum free partial withdrawals (See table below):

| | | | | PV | | |
|---|---|---|---|---|---|---|
| | | | | Through | | |
| | | | PV | Future | PV of | |
| | | | Through | Date | Full | |
| | | | Future | of Free | Surrender | |
| | | | Date of | Partial | on the | |
| Future | Mortality | | Death | With- | Future | |
| Date | Rate | In Force | Benefit | drawals | Date | Total |
| 0 | | 1.000000 | 0.00 | 0.00 | 8920.00 | 8920.00 |
| 1 | 0.00453 | 0.99547 | 46.17 | 950.33 | 7678.74 | 8675.23 |
| 2 | 0.00488 | 0.99061 | 90.33 | 1766.58 | 6777.30 | 8634.22 |
| 3 | 0:00523 | 0.98543 | 133.89 | 2469.23 | 6036.85 | 8639.96 |
| 4 | 0.00559 | 0.97992 | 176.09 | 3145.36 | 5415.79 | 8737.24 |
| 5 | 0.00599 | 0.97405 | 215.46 | 3722.80 | 4737.65 | 8675.92 |
| 6 | 0.00643 | 0.96779 | 253.49 | 4217.03 | 4167.76 | 8638.28 |
| 7 | 0.00693 | 0.96108 | 290.46 | 4640.50 | 3683.83 | 8614.79 |
| 8 | 0.00752 | 0.95386 | 326.68 | 5028.29 | 3245.81 | 8600.77 |
| 9 | 0.00821 | 0.94602 | 362.18 | 5358.74 | 2833.73 | 8554.64 |
| 10 | 0.00901 | 0.93750 | 397.25 | 5640.86 | 2487.43 | 8525.54 |
| 11 | 0.00994 | 0.92818 | 432.14 | 5881.90 | 2216.03 | 8530.07 |
| 12 | 0.01102 | 0.91796 | 463.63 | 6102.79 | 1988.07 | 8554.49 |

The reserve is the greater of the largest present value from step 1 and step 2; in this case, it is $8,920.00.

The valuation of annuity income payments for contracts in the payout phase is based on the appropriate valuation mortality table applicable for the calendar year of contract issue and the appropriate SPIA valuation interest rate applicable for the calendar year of annuitization.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

1. A non-transitory machine readable medium having stored thereon data representing sequences of instructions for determining an enhanced death benefit rider charge C for an enhanced minimum death benefit guarantee equity-indexed deposit product, wherein said product comprises:
a set of equity-indexed crediting parameters I,
an enhanced minimum death benefit rollup percentage E,
a set of profitability requirements R, and
a principal amount P,
wherein the enhanced minimum death benefit guarantee equity-indexed deposit product provides an enhanced minimum death benefit equal to the principal amount P accumulated at the enhanced minimum death benefit rollup percentage E, and wherein, when the instructions are executed by a computer system, the instructions cause the system to perform operations comprising:
setting the value of R, E, P, and I at a time when said product is purchased;
generating a set of equity index scenarios consistent with valuation parameters; and
selecting the enhanced death benefit rider charge C from a plurality of trial values, wherein selecting the enhanced death benefit rider charge C from a plurality of trial values comprises:
for each trial value, (i) calculating an observed distribution D of profitability using said equity index scenarios, and (ii) comparing the observed distribution D with the set of profitability requirements R, wherein the observed distribution D provides respective returns on investment for a plurality of ages, and wherein the set of profitability requirements includes a non-zero target return on investment,
wherein the enhanced death benefit rider charge C is selected such that the observed distribution D for the selected enhanced death benefit rider charge C satisfies the set of profitability requirements R.

2. The non-transitory machine readable medium of claim 1, wherein the steps further comprise increasing an account value A at a maturity date M by an excess of a death benefit over said account value A, wherein said maturity date M is selected by a seller of said product.

3. The non-transitory machine readable medium of claim 1, wherein the operations further comprise increasing an account value A at a maturity date M by an excess of a death benefit over said account value A, wherein said maturity date M is selected by an owner of said product on or after a purchase date of said product, and said maturity date M is subject to a earliest permissible date Mₘᵢₙ and a latest permissible date Mₘₐₓ.

4. The machine readable medium of claim 1, wherein the operations further comprise applying the enhanced minimum death benefit rollup percentage E only until a rollup limit date L, wherein said rollup limit date L is selected by a seller of said product.

5. The non-transitory machine readable medium of claim 1, wherein the operations further comprise applying said enhanced minimum death benefit rollup percentage E only until a ratio of said enhanced minimum rollup death benefit to said principal P equals a maximum rollup limit ratio M selected by a seller of said product, wherein said ratio is adjusted for withdrawals.

6. The non-transitory machine readable medium of claim 1, wherein selecting the enhanced death benefit rider charge C from a plurality of trial values further comprises:
iteratively selecting the trial values in order to obtain the enhanced death benefit rider charge C, wherein the trial values are iteratively selected until convergence is reached between the observed distribution D of a given trial value with the set of profitability requirements R.

7. The non-transitory machine readable medium of claim 1, wherein the operations further comprise:
generating a set of yield curve scenarios, wherein the yield curve scenarios are also consistent with the valuation parameters.
